(19) United States
(12) Patent Application Publication
(10) Pub. No.: US 2005/0201673 A1
(43) Pub. Date: Sep. 15, 2005

(54) APPARATUS, METHOD, AND COMPUTER PROGRAM PRODUCT FOR UNITARY DISPLAY SYSTEM

(75) Inventor: Sutherland C. Ellwood JR., Clinton Corners, NY (US)

Correspondence Address: PANORAMA FLAT;C/O PATENT LAW OFFICES OF MICHAEL E. WOODS, 112 BARN ROAD, TIBURON, CA, 94920, US

(73) Assignee: PANORAMA FLAT LTD., Perth (AU)

(21) Appl. No.: 10/906,255

(22) Filed: Feb. 11, 2005

Related U.S. Application Data
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,220, filed on Feb. 9, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,221, filed on Feb. 9, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,222, filed on Feb. 9, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,223, filed on Feb. 9, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,224, filed on Feb. 9, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,225, filed on Feb. 9, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 11/011,751, filed on Dec. 14, 2004.
(63) Continuation-in-part of application No. 11/011,496, filed on Dec. 14, 2004.
(63) Continuation-in-part of application No. 11/011,762, filed on Dec. 14, 2004.
(63) Continuation-in-part of application No. 11/011,770, filed on Dec. 14, 2004.
(63) Continuation-in-part of application No. 10/906,226, filed on Feb. 9, 2005.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
(63) Continuation-in-part of application No. 11/011,761, filed on Dec. 14, 2004.
(63) Continuation-in-part of application No. 10/812,294, filed on Mar. 29, 2004.
(63) Continuation-in-part of application No. 10/811,782, filed on Mar. 29, 2004.
(63) Continuation-in-part of application No. 10/812,295, filed on Mar. 29, 2004.
Application No. 10/906,226 is a continuation-in-part of application No. 11/011,751, filed on Dec. 14, 2004.
Application No. 10/906,226 is a continuation-in-part of application No. 10/812,294, filed on Mar. 29, 2004.
Application No. 10/906,226 is a continuation-in-part of application No. 10/811,782, filed on Mar. 29, 2004.
Application No. 10/906,226 is a continuation-in-part of application No. 10/812,295, filed on Mar. 29, 2004.
Application No. 10/906,226 is a continuation-in-part of application No. 11/011,496, filed on Dec. 14, 2004.
Application No. 10/906,226 is a continuation-in-part of application No. 10/812,294, filed on Mar. 29, 2004.
Application No. 10/906,226 is a continuation-in-part of application No. 10/811,782, filed on Mar. 29, 2004.
Application No. 10/906,226 is a continuation-in-part of application No. 10/812,295, filed on Mar. 29, 2004.
Application No. 10/906,226 is a continuation-in-part of application No. 11/011,762, filed on Dec. 14, 2004.
Application No. 10/906,226 is a continuation-in-part of application No. 10/812,294, filed on Mar. 29, 2004.
Application No. 10/906,226 is a continuation-in-part of application No. 10/811,782, filed on Mar. 29, 2004.
Application No. 10/906,226 is a continuation-in-part of application No. 10/812,295, filed on Mar. 29, 2004.
Application No. 10/906,226 is a continuation-in-part of application No. 11/011,770, filed on Dec. 14, 2004.
Application No. 10/906,226 is a continuation-in-part of application No. 10/812,294, filed on Mar. 29, 2004.
Application No. 11/011,770 is a continuation-in-part of application No. 10/811,782, filed on Mar. 29, 2004.
Application No. 11/011,770 is a continuation-in-part of application No. 10/812,295, filed on Mar. 29, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.
(60) Provisional application No. 60/544,591, filed on Feb. 12, 2004.

(51) Int. Cl. G02B 6/26; G02B 6/42; G02F 1/295

(52) U.S. Cl. 385/17; 385/4; 385/6; 385/14; 385/8; 385/16; 385/136; 385/137

(57) ABSTRACT

An apparatus and method for a unitary display system. The unitary display system including an illumination system for generating a plurality of input wave_components in a first plurality of waveguide channels; and a modulating system, integrated with the illumination system, for receiving the plurality of input wave_components in a second plurality of waveguide channels and producing a plurality of output wave_components collectively defining successive image sets.

### CROSSREF

This application claims benefit of U.S. Provisional Application No. 60/544,591 filed 12 Feb. 2004, and is a Continuation-In-Part of each of the following U.S. patent application Ser. Nos. 10/812,294, 10/811,782, and 10/812,295 (each filed 29 Mar. 2004); and is a Continuation-In-Part of each of the following U.S. patent application Ser. Nos. 11/011,761, 11/011,751, 11/011,496, 11/011,762, and 11/011,770 (each filed 14 Dec. 2004); and is a Continuation-In-Part of each of the following U.S. patent application Ser. Nos. 10/906,220, 10/906,221, 10/906,222, 10/906,223, 10/906,224, 10/906,226, and 10/906,226 (each filed 9 Feb. 2005). The disclosures of which are each incorporated in their entireties for all purposes.

### BACKGROUND

The present invention relates generally to a transport for propagating radiation, and more specifically to a waveguide having a guiding channel that includes optically-active constituents that enhance a responsiveness of a radiation-influencing property of the waveguide to an outside influence.

The Faraday Effect is a phenomenon wherein a plane of polarization of linearly polarized light rotates when the light is propagated through a transparent medium placed in a magnetic field and in parallel with the magnetic field. An effectiveness of the magnitude of polarization rotation varies with the strength of the magnetic field, the Verdet constant inherent to the medium and the light path length. The empirical angle of rotation is given by
β=VBd, (Eq. 1)
where V is called the Verdet constant (and has units of arc minutes cm−1 Gauss−1), B is the magnetic field and d is the propagation distance subject to the field. In the quantum mechanical description, Faraday rotation occurs because imposition of a magnetic field alters the energy levels.

It is known to use discrete materials (e.g., iron-containing garnet crystals) having a high Verdet constant for measurement of magnetic fields (such as those caused by electric current as a way of evaluating the strength of the current) or as a Faraday rotator used in an optical isolator. An optical isolator includes a Faraday rotator to rotate by 45° the plane of polarization, a magnet for application of magnetic field, a polarizer, and an analyzer. Conventional optical isolators have been of the bulk type wherein no waveguide (e.g., optical fiber) is used.

In conventional optics, magneto-optical modulators have been produced from discrete crystals containing paramagnetic and ferromagnetic materials, particularly garnets (yttrium/iron garnet for example). Devices such as these require considerable magnetic control fields. The magneto-optical effects are also used in thin-layer technology, particularly for producing non-reciprocal devices, such as non-reciprocal junctions. Devices such as these are based on a conversion of modes by Faraday Effect or by Cotton-Moutton effect.

A further drawback to using paramagnetic and ferromagnetic materials in magneto-optic devices is that these materials may adversely affect properties of the radiation other than polarization angle, such as for example amplitude, phase, and/or frequency.

The prior art has known the use of discrete magneto-optical bulk devices (e.g., crystals) for collectively defining a display device. These prior art displays have several drawbacks, including a relatively high cost per picture element (pixel), high operating costs for controlling individual pixels, increasing control complexity that does not scale well for relatively large display devices.

Conventional imaging systems may be roughly divided into two categories: (a) flat panel displays (FPDs), and (b) projection systems (which include cathode ray tubes (CRTs) as emissive displays). Generally speaking, the dominant technologies for the two types of systems are not the same, although there are exceptions. These two categories have distinct challenges for any prospective technology, and existing technologies have yet to satisfactorily conquer these challenges.

A main challenge confronting existing FPD technology is cost, as compared with the dominant cathode ray tube (CRT) technology (“flat panel” means “flat” or “thin” compared to a CRT display, whose standard depth is nearly equal to the width of the display area).

To achieve a given set of imaging standards, including resolution, brightness, and contrast, FPD technology is roughly three to four times more expensive than CRT technology. However, the bulkiness and weight of CRT technology, particularly as a display area is scaled larger, is a major drawback. Quests for a thin display have driven the development of a number of technologies in the FPD arena.

High costs of FPD are largely due to the use of delicate component materials in the dominant liquid crystal diode (LCD) technology, or in the less-prevalent gas plasma technology. Irregularities in the nematic materials used in LCDs result in relatively high defect rates; an array of LCD elements in which an individual cell is defective often results in the rejection of an entire display, or a costly substitution of the defective element.

For both LCD and gas-plasma display technology, the inherent difficulty of controlling liquids or gasses in the manufacturing of such displays is a fundamental technical and cost limitation.

An additional source of high cost is the demand for relatively high switching voltages at each light valve/emission element in the existing technologies. Whether for rotating the nematic materials of an LCD display, which in turn changes a polarization of light transmitted through the liquid cell, or excitation of gas cells in a gas plasma display, relatively high voltages are required to achieve rapid switching speeds at the imaging element. For LCDs, an “active matrix,” in which individual transistor elements are assigned to each imaging location, is a high-cost solution.

As image quality standards increase, for high-definition television (HDTV) or beyond, existing FPD technologies cannot now deliver image quality at a cost that is competitive with CRT's. The cost differential at this end of the quality range is most pronounced. And delivering 35 mm film-quality resolution, while technically feasible, is expected to entail a cost that puts it out of the realm of consumer electronics, whether for televisions or computer displays.

For projection systems, there are two basic subclasses: television (or computer) displays, and theatrical motion picture projection systems. Relative cost is a major issue in the context of competition with traditional 35 mm film projection equipment. However, for HDTV, projection systems represent the low-cost solution, when compared against conventional CRTs, LCD FPDs, or gas-plasma FPDs.

Current projection system technologies face other challenges. HDTV projection systems face the dual challenge of minimizing a depth of the display, while maintaining uniform image quality within the constraints of a relatively short throw-distance to the display surface. This balancing typically results in a less-than-satisfactory compromise at the price of relatively lower cost.

A technically-demanding frontier for projection systems, however, is in the domain of the movie theater. Motion-picture screen installations are an emerging application area for projection systems, and in this application, issues regarding console depth versus uniform image quality typically do not apply. Instead, the challenge is in equaling (at minimum) the quality of traditional 35 mm film projectors, at a competitive cost. Existing technologies, including direct Drive Image Light Amplifier (“D-ILA”), digital light processing (“DLP”), and grating-light-valve (“GLV”)-based systems, while recently equaling the quality of traditional film projection equipment, have significant cost disparities as compared to traditional film projectors.

Direct Drive Image Light Amplifier is a reflective liquid crystal light valve device developed by JVC Projectors. A driving integrated circuit (“IC”) writes an image directly onto a CMOS based light valve. Liquid crystals change the reflectivity in proportion to a signal level. These vertically aligned (homeoptropic) crystals achieve very fast response times with a rise plus fall time less than 16 milliseconds. Light from a xenon or ultra high performance (“UHP”) metal halide lamp travels through a polarized beam splitter, reflects off the D-ILA device, and is projected onto a screen.

At the heart of a DLP™ projection system is an optical semiconductor known as a Digital Micromirror Device, or DMD chip, which was pioneered by Dr. Larry Hornbeck of Texas Instruments in 1987. The DMD chip is a sophisticated light switch. It contains a rectangular array of up to 1.3 million hinge-mounted microscopic mirrors; each of these micromirrors measures less than one-fifth the width of a human hair, and corresponds to one pixel in a projected image. When a DMD chip is coordinated with a digital video or graphic signal, a light source, and a projection lens, its mirrors reflect an all-digital image onto a screen or other surface. The DMD and the sophisticated electronics that surround it are called Digital Light Processing™ technology.

A process called GLV (Grating-Light-Valve) is being developed. A prototype device based on the technology achieved a contrast ratio of 3000:1 (typical high-end projection displays today achieve only 1000:1). The device uses three lasers chosen at specific wavelengths to deliver color. The three lasers are: red (642 nm), green (532 nm), and blue (457 nm). The process uses MEMS technology (MicroElectroMechanical) and consists of a microribbon array of 1,080 pixels on a line. Each pixel consists of six ribbons, three fixed and three which move up/down. When electrical energy is applied, the three mobile ribbons form a kind of diffraction grating which “filters” out light.

Part of the cost disparity is due to the inherent difficulties those technologies face in achieving certain key image quality parameters at a low cost. Contrast, particularly in quality of “black,” is difficult to achieve for micro-mirror DLP. GLV, while not facing this difficulty (achieving a pixel nullity, or black, through optical grating wave interference), instead faces the difficulty of achieving an effectively film-like intermittent image with a line-array scan source.

Existing technologies, either LCD or MEMS-based, are also constrained by the economics of producing devices with at least 1 K×1 K arrays of elements (micro-mirrors, liquid crystal on silicon (“LCoS”), and the like). Defect rates are high in the chip-based systems when involving these numbers of elements, operating at the required technical standards.

It is known to use stepped-index optical fibers in cooperation with the Faraday Effect for various telecommunications uses. The telecommunications application of optical fibers is well-known, however there is an inherent conflict in applying the Faraday Effect to optical fibers because the telecommunications properties of conventional optical fibers relating to dispersion and other performance metrics are not optimized for, and in some cases are degraded by, optimizations for the Faraday Effect. In some conventional optical fiber applications, ninety-degree polarization rotation is achieved by application of a one hundred Oersted magnetic field over a path length of fifty-four meters. Placing the fiber inside a solenoid and creating the desired magnetic field by directing current through the solenoid applies the desired field. For telecommunications uses, the fifty-four meter path length is acceptable when considering that it is designed for use in systems having a total path length measured in kilometers.

Another conventional use for the Faraday Effect in the context of optical fibers is as a system to overlay a low-rate data transmission on top of conventional high-speed transmission of data through the fiber. The Faraday Effect is used to slowly modulate the high-speed data to provide out-of-band signaling or control. Again, this use is implemented with the telecommunications use as the predominate consideration.

In these conventional applications, the fiber is designed for telecommunications usage and any modification of the fiber properties for participation in the Faraday Effect is not permitted to degrade the telecommunications properties that typically include attenuation and dispersion performance metrics for kilometer+−length fiber channels.

Once acceptable levels were achieved for the performance metrics of optical fibers to permit use in telecommunications, optical fiber manufacturing techniques were developed and refined to permit efficient and cost-effective manufacturing of extremely long-lengths of optically pure and uniform fibers. A high-level overview of the basic manufacturing process for optical fibers includes manufacture of a perform glass cylinder, drawing fibers from the preform, and testing the fibers. Typically a perform blank is made using a modified chemical vapor deposition (MCVD) process that bubbles oxygen through silicon solutions having a requisite chemical composition necessary to produce the desired attributes (e.g., index of refraction, coefficient of expansion, melting point, etc.) of the final fiber. The gas vapors are conducted to an inside of a synthetic silica or quartz tube (cladding) in a special lathe. The lathe is turned and a torch moves along an outside of the tube. Heat from the torch causes the chemicals in the gases to react with oxygen and form silicon dioxide and germanium dioxide and these dioxides deposit on the inside of the tube and fuse together to form glass. The conclusion of this process produces the blank preform.

After the blank preform is made, cooled, and tested, it is placed inside a fiber drawing tower having the preform at a top near a graphite furnace. The furnace melts a tip of the preform resulting in a molten “glob” that begins to fall due to gravity. As it falls, it cools and forms a strand of glass. This strand is threaded through a series of processing stations for applying desired coatings and curing the coatings and attached to a tractor that pulls the strand at a computer-monitored rate so that the strand has the desired thickness. Fibers are pulled at about a rate of thirty-three to sixty-six feet/second with the drawn strand wound onto a spool. It is not uncommon for these spools to contain more than one point four (1.4) miles of optical fiber.

This finished fiber is tested, including tests for the performance metrics. These performance metrics for telecommunications grade fibers include: tensile strength (100,000 pounds per square inch or greater), refractive index profile (numerical aperture and screen for optical defects), fiber geometry (core diameter, cladding dimensions and coating diameters), attenuation (degradation of light of various wavelengths over distance), bandwidth, chromatic dispersion, operating temperature/range, temperature dependence on attenuation, and ability to conduct light underwater.

In 1996, a variation of the above-described optical fibers was demonstrated that has since been termed photonic crystal fibers (PCFs). A PCF is an optical fiber/waveguiding structure that uses a microstructured arrangement of low-index material in a background material of higher refractive index. The background material is often undoped silica and the low index region is typically provided by air voids running along the length of the fiber. PCFs are divided into two general categories: (1) high index guiding fibers, and (2) low index guiding fibers.

Similar to conventional optic fibers described previously, high index guiding fibers are guiding light in a solid core by the Modified Total Internal Reflection (MTIR) principle. Total internal reflection is caused by the lower effective index in the microstructured air-filled region.

Low index guiding fibers guide light using a photonic bandgap (PBG) effect. Light is confined to the low index core as the PBG effect makes propagation in the microstructured cladding region impossible.

While the term “conventional waveguide structure” is used to include the wide range of waveguiding structures and methods, the range of these structures may be modified as described herein to implement embodiments of the present invention. The characteristics of different fiber types aides are adapted for the many different applications for which they are used. Operating a fiber optic system properly relies on knowing what type of fiber is being used and why.

Conventional systems include single-mode, multimode, and PCF waveguides, and also include many sub-varieties as well. For example, multimode fibers include step-index and graded-index fibers, and single-mode fibers include step-index, matched clad, depressed clad and other exotic structures. Multimode fiber is best designed for shorter transmission distances, and is suited for use in LAN systems and video surveillance. Single-mode fiber are best designed for longer transmission distances, making it suitable for long-distance telephony and multichannel television broadcast systems. “Air-clad” or evanescently-coupled waveguides include optical wire and optical nano-wire.

Stepped-index generally refers to provision of an abrupt change of an index of refraction for the waveguide—a core has an index of refraction greater than that of a cladding. Graded-index refers to structures providing a refractive index profile that gradually decreases farther from a center of the core (for example the core has a parabolic profile). Single-mode fibers have developed many different profiles tailored for particular applications (e.g., length and radiation frequency(ies) such as non dispersion-shifted fiber (NDSF), dispersion-shifted fiber (DSF) and non-zero-dispersion-shifted fiber (NZ-DSF)). An important variety of single-mode fiber has been developed referred to as polarization-maintaining (PM) fiber. All other single-mode fibers discussed so far have been capable of carrying randomly polarized light. PM fiber is designed to propagate only one polarization of the input light. PM fiber contains a feature not seen in other fiber types. Besides the core, there are additional (2) longitudinal regions called stress rods. As their name implies, these stress rods create stress in the core of the fiber such that the transmission of only one polarization plane of light is favored.

As discussed above, conventional magneto-optical systems, particularly Faraday rotators and isolators, have employed special magneto-optical materials that include rare earth doped garnet crystals and other specialty materials, commonly an yttrium-iron-garnet (YIG) or a bismuth-substituted YIG. A YIG single crystal is grown using a floating zone (FZ) method. In this method, Y₂O₃ and Fe₂O₃ are mixed to suit the stoichiometric composition of YIG, and then the mixture is sintered. The resultant sinter is set as a mother stick on one shaft in an FZ furnace, while a YIG seed crystal is set on the remaining shaft. The sintered material of a prescribed formulation is placed in the central area between the mother stick and the seed crystal in order to create the fluid needed to promote the deposition of YIG single crystal. Light from halogen lamps is focused on the central area, while the two shafts are rotated. The central area, when heated in an oxygenic atmosphere, forms a molten zone. Under this condition, the mother stick and the seed are moved at a constant speed and result in the movement of the molten zone along the mother stick, thus growing single crystals from the YIG sinter.

Since the FZ method grows crystal from a mother stick that is suspended in the air, contamination is precluded and a high-purity crystal is cultivated. The FZ method produces ingots measuring 012×120 mm.

Bi-substituted iron garnet thick films are grown by a liquid phase epitaxy (LPE) method that includes an LPE furnace. Crystal materials and a PbO—B₂O₃ flux are heated and made molten in a platinum crucible. Single crystal wafers, such as (GdCa)₂(GaMgZr)₅O₁₂, are soaked on the molten surface while rotated, which causes a Bi-substituted iron garnet thick film to be grown on the wafers. Thick films measuring as much as 3 inches in diameter can be grown.

To obtain 45° Faraday rotators, these films are ground to a certain thickness, applied with anti-reflective coating, and then cut into 1-2 mm squares to fit the isolators. Having a greater Faraday rotation capacity than YIG single crystals, Bi-substituted iron garnet thick films must be thinned in the order of 100 μm, so higher-precision processing is required.

Newer systems provide for the production and synthesis of Bismuth-substituted yttrium-iron-garnet (Bi—YIG) materials, thin-films and nanopowders. nGimat Co., at 5313 Peachtree Industrial Boulevard, Atlanta, Ga. 30341 uses a combustion chemical vapor deposition (CCVD) system for production of thin film coatings. In the CCVD process, precursors, which are the metal-bearing chemicals used to coat an object, are dissolved in a solution that typically is a combustible fuel. This solution is atomized to form microscopic droplets by means of a special nozzle. An oxygen stream then carries these droplets to a flame where they are combusted. A substrate (a material being coated) is coated by simply drawing it in front of the flame. Heat from the flame provides energy that is required to vaporize the droplets and for the precursors to react and deposit (condense) on the substrate.

Additionally, epitaxial liftoff has been used for achieving heterogeneous integration of many III-V and elemental semiconductor systems. However, it has been difficult using some processes to integrate devices of many other important material systems. A good example of this problem has been the integration of single-crystal transition metal oxides on semiconductor platforms, a system needed for on-chip thin film optical isolators. An implementation of epitaxial liftoff in magnetic garnets has been reported. Deep ion implantation is used to create a buried sacrificial layer in single-crystal yttrium iron garnet (YIG) and bismuth-substituted YIG (Bi—YIG) epitaxial layers grown on gadolinium gallium garnet (GGG). The damage generated by the implantation induces a large etch selectivity between the sacrificial layer and the rest of the garnet. Ten-micron-thick films have been lifted off from the original GGG substrates by etching in phosphoric acid. Millimeter-size pieces have been transferred to the silicon and gallium arsenide substrates.

Further, researchers have reported a multilayer structure they call a magneto-optical photonic crystal that displays one hundred forty percent (140%) greater Faraday rotation at 748 nm than a single-layer bismuth iron garnet film of the same thickness. Current Faraday rotators are generally single crystals or epitaxial films. The single-crystal devices, however, are rather large, making their use in applications such as integrated optics difficult. And even the films display thicknesses on the order of 500 μm, so alternative material systems are desirable. The use of stacked films of iron garnets, specifically bismuth and yttrium iron garnets has been investigated. Designed for use with 750-nm light, a stack featured four heteroepitaxial layers of 81-nm-thick yttrium iron garnet (YIG) atop 70-nm-thick bismuth iron garnet (BIG), a 279-nm-thick central layer of BIG, and four layers of BIG atop YIG. To fabricate the stack, a pulsed laser deposition using an LPX305i 248-nm KrF excimer laser was used.

As seen from the discussion above, the prior art employs specialty magneto-optic materials in most magneto-optic systems, but it has also been known to employ the Faraday Effect with less traditional magneto-optic materials such as the non-PCF optical fibers by creating the necessary magnetic field strength—as long as the telecommunications metrics are not compromised. In some cases, post-manufacturing methods are used in conjunction with pre-made optical fibers to provide certain specialty coatings for use in certain magneto-optical applications. The same is true for specialty magneto-optical crystals and other bulk implementations in that post-manufacture processing of the premade material is sometimes necessary to achieve various desired results. Such extra processing increases the final cost of the special fiber and introduces additional situations in which the fiber may fail to meet specifications. Since many magneto-applications typically include a small number (typically one or two) of magneto-optical components, the relatively high cost per unit is tolerable. However, as the number of desired magneto-optical components increases, the final costs (in terms of dollars and time) are magnified and in applications using hundreds or thousands of such components, it is imperative to greatly reduce unit cost.

What is needed is an alternative waveguide technology that offers advantages over the prior art to enhance a responsiveness of a radiation-influencing property of the waveguide to an outside influence while reducing unit cost and increasing manufacturability, reproducibility, uniformity, and reliability.

### BRIEFSUMM

Disclosed is an apparatus and method for a unitary display system. The unitary display system including an illumination system for generating a plurality of input wave_components in a first plurality of waveguide channels; and a modulating system, integrated with the illumination system, for receiving the plurality of input wave_components in a second plurality of waveguide channels and producing a plurality of output wave_components collectively defining successive image sets.

It is also a preferred embodiment of the present invention for a unitary display manufacturing method, the method including: a) forming an illumination system for generating a plurality of input wave_components in a first plurality of waveguide channels; and b) forming a modulating system, integrated with the illumination system, for receiving the plurality of input wave_components in a second plurality of waveguide channels and producing a plurality of output wave_components collectively defining successive image sets.

The apparatus, method, computer program product and propagated signal of the present invention provide an advantage of using modified and mature waveguide manufacturing processes. In a preferred embodiment, the waveguide is an optical transport, preferably an optical fiber or waveguide channel adapted to enhance short-length property influencing characteristics of the influencer by including optically-active constituents while preserving desired attributes of the radiation. In a preferred embodiment, the property of the radiation to be influenced includes a polarization state of the radiation and the influencer uses a Faraday Effect to control a polarization rotation angle using a controllable, variable magnetic field propagated parallel to a transmission axis of the optical transport. The optical transport is constructed to enable the polarization to be controlled quickly using low magnetic field strength over very short optical paths. Radiation is initially controlled to produce a wave component having one particular polarization; the polarization of that wave component is influenced so that a second polarizing filter modulates an amplitude of emitted radiation in response to the influencing effect. In the preferred embodiment, this modulation includes extinguishing the emitted radiation. The incorporated patent applications, the priority applications and related-applications, disclose Faraday structured waveguides, Faraday structured waveguide modulators, displays and other waveguide structures and methods that are cooperative with the present invention.

Leveraging the mature and efficient fiber optic waveguide manufacturing process as disclosed herein as part of the present invention for use in production of low-cost, uniform, efficient magneto-optic system elements provides an alternative waveguide technology that offers advantages over the prior art to enhance a responsiveness of a radiation-influencing property of the waveguide to an outside influence while reducing unit cost and increasing manufacturability, reproducibility, uniformity, and reliability.

### DESCDRAWINGS

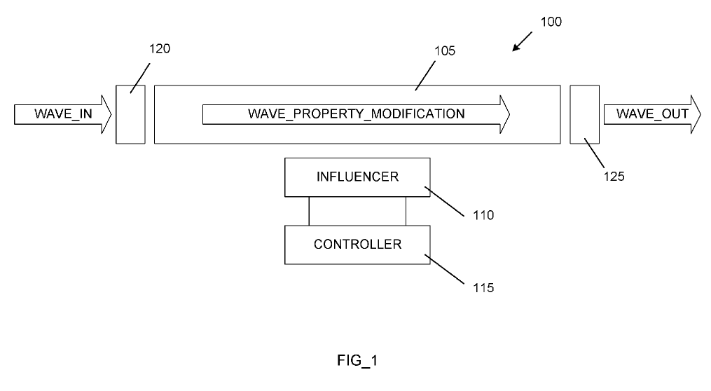

FIG. 1 is a general schematic plan view of a preferred embodiment of the present invention;

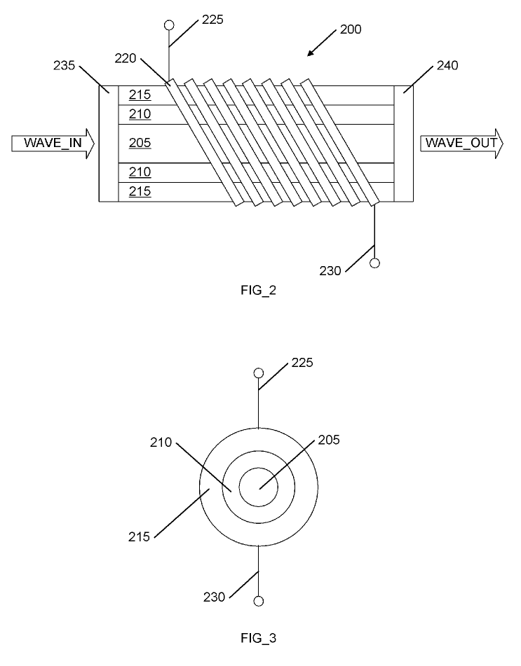

FIG. 2 is a detailed schematic plan view of a specific implementation of the preferred embodiment shown in FIG. 1;

FIG. 3 is an end view of the preferred embodiment shown in FIG. 2;

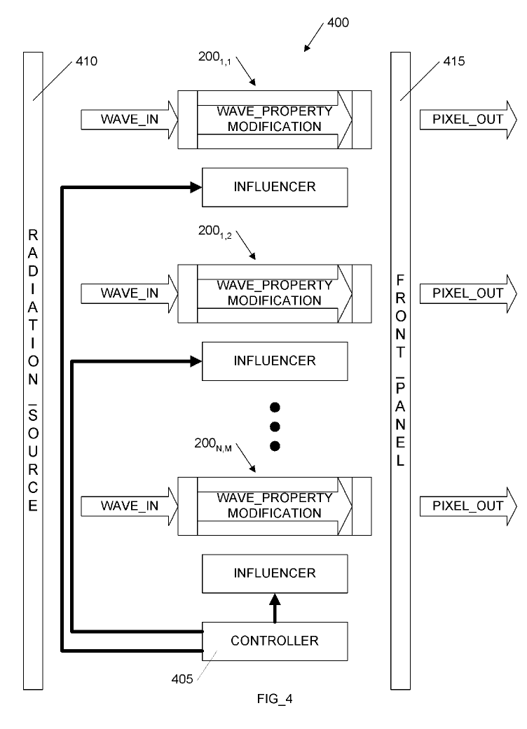

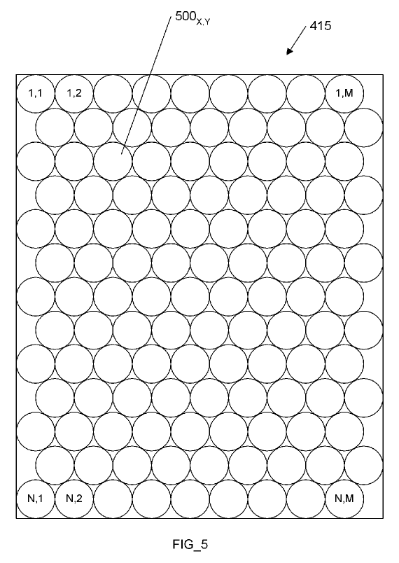

FIG. 4 is a schematic block diagram of a preferred embodiment for a display assembly;

FIG. 5 is a view of one arrangement for output ports of the front panel shown in FIG. 4;

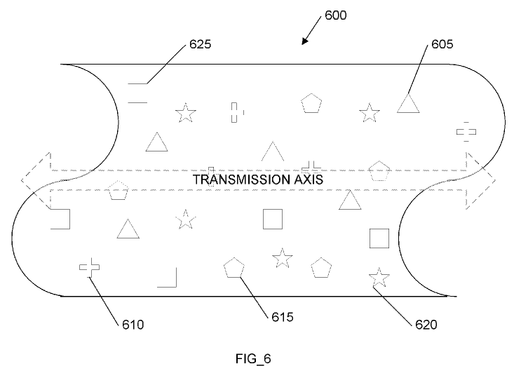

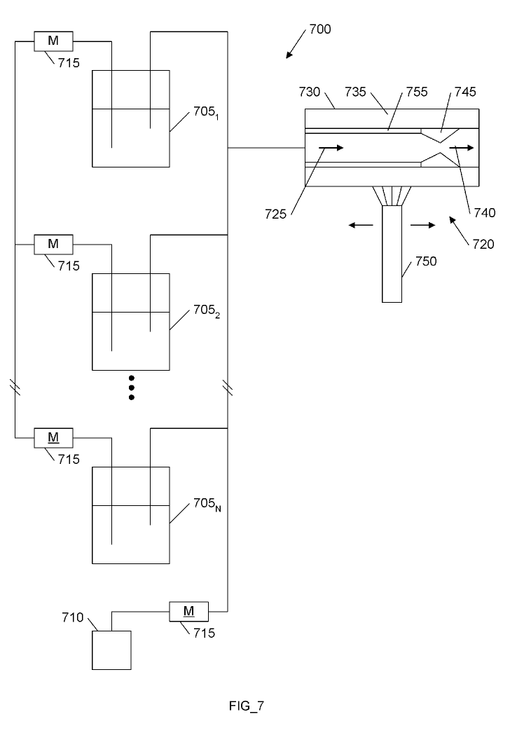

FIG. 6 is a schematic representation of a preferred embodiment of the present invention for a portion of the structured waveguide shown in FIG. 2;

FIG. 7 is a schematic block diagram of a representative waveguide manufacturing system for making a preferred embodiment of a waveguide preform of the present invention;

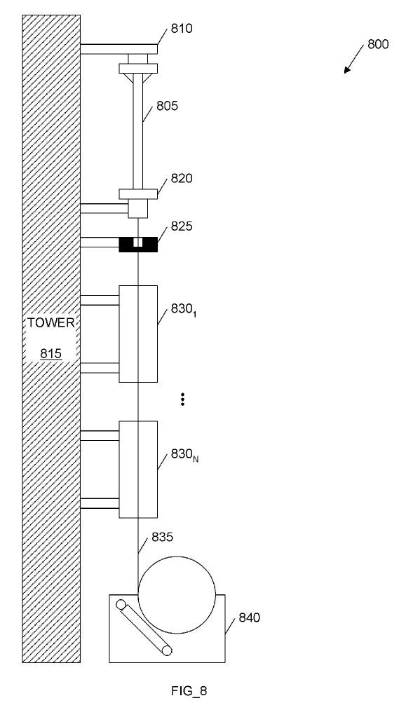

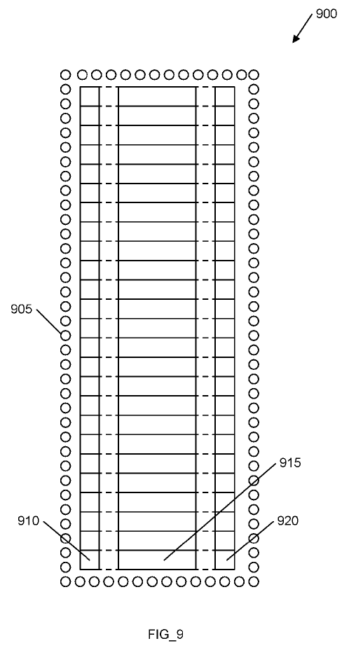

FIG. 8 is a schematic diagram of a representative fiber drawing system for making a preferred embodiment of the present invention;

FIG. 9 is a general schematic diagram of a simplified unitary panel waveguide-based display;

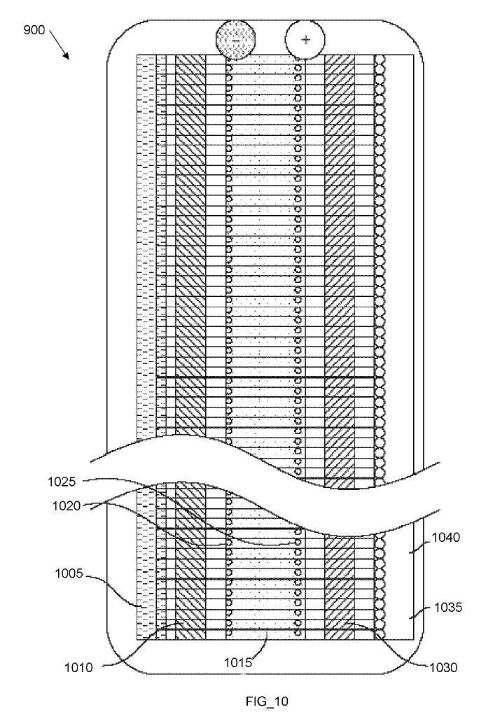

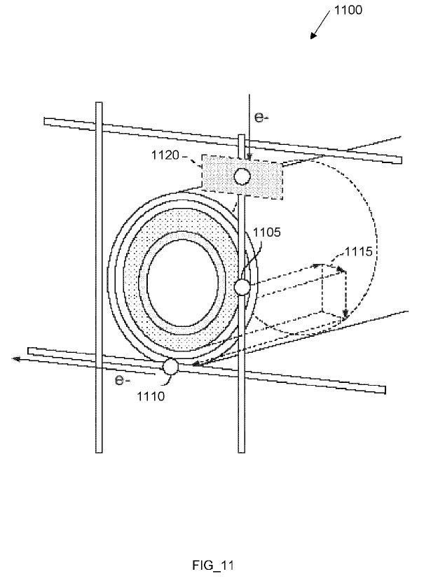

FIG. 10 is a detailed schematic diagram of the display shown in FIG. 9;

FIG. 11 is a schematic diagram of an addressing grid 1100 according to a preferred embodiment of the present invention;

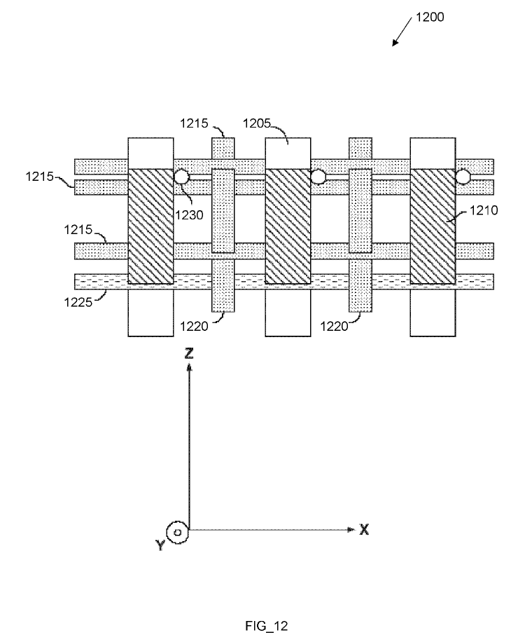

FIG. 12 is a schematic diagram of an “X” ribbon structural fiber system according to a preferred embodiment of the present invention;

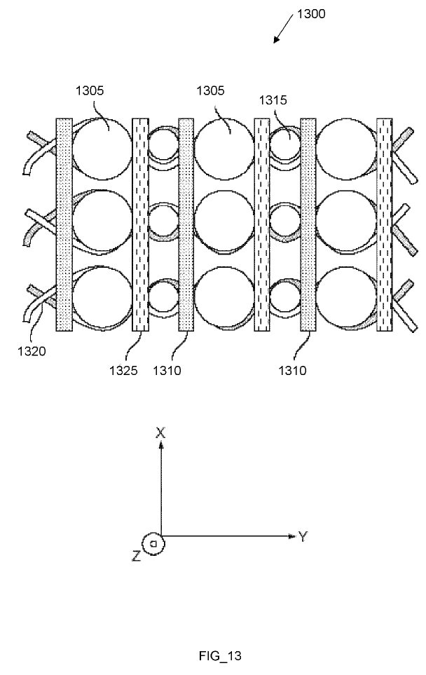

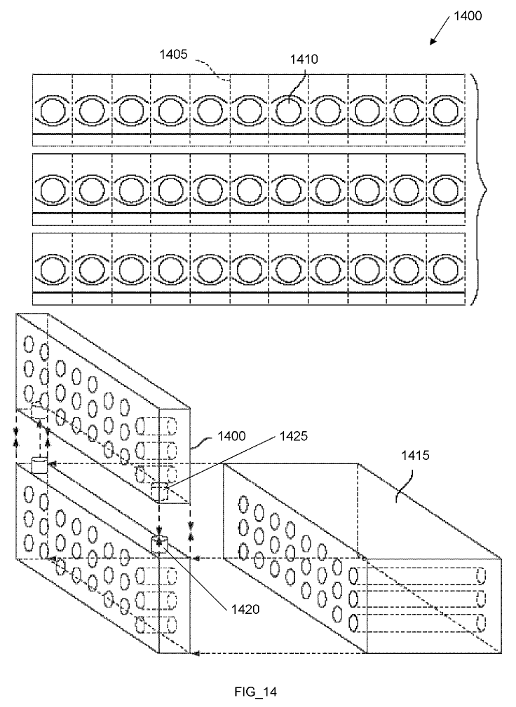

FIG. 13 is a schematic diagram of a “Y” ribbon structural fiber system according to a preferred embodiment of the present invention;

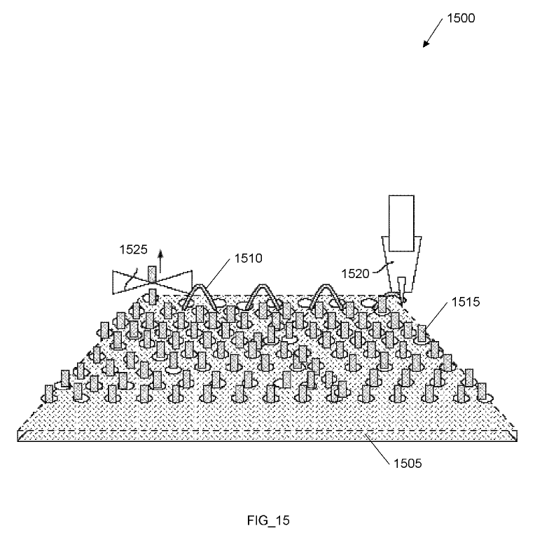

FIG. 14 is a schematic diagram of a preferred embodiment for a modular switching matrix used in the display shown in FIG. 9 and FIG. 10;

FIG. 15 is a schematic diagram of a first alternate preferred embodiment for a modular switching matrix used in the display shown in FIG. 9 and FIG. 10;

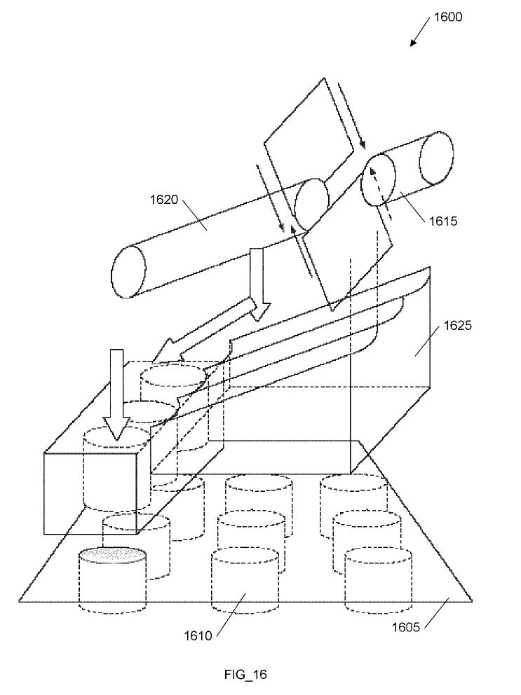

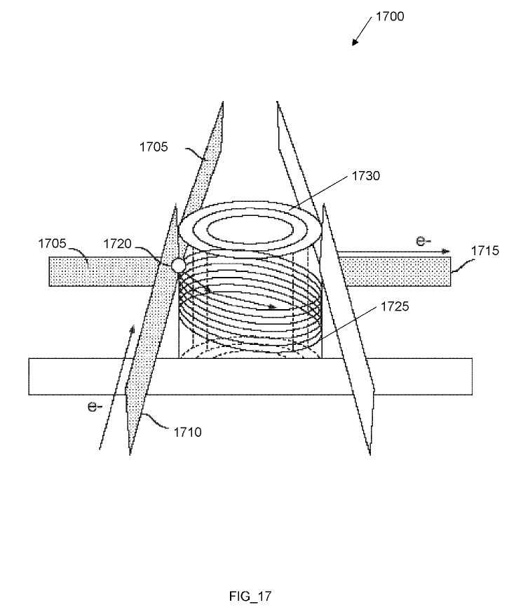

FIG. 16 is a schematic diagram of a second alternate preferred embodiment for a modular switching matrix used in the display shown in FIG. 9 and FIG. 10; and

FIG. 17 is a schematic diagram of a third alternate preferred embodiment for a modular switching matrix used in the display shown in FIG. 9 and FIG. 10.

### DETAILEDDESC

The present invention relates to an alternative waveguide technology that offers advantages over the prior art to enhance a responsiveness of a radiation-influencing property of the waveguide to an outside influence while reducing unit cost and increasing manufacturability, reproducibility, uniformity, and reliability. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In the following description, three terms have particular meaning in the context of the present invention: (1) optical transport, (2) property influencer, and (3) extinguishing. For purposes of the present invention, an optical transport is a waveguide particularly adapted to enhance the property influencing characteristics of the influencer while preserving desired attributes of the radiation. In a preferred embodiment, the property of the radiation to be influenced includes its polarization rotation state and the influencer uses a Faraday Effect to control the polarization angle using a controllable, variable magnetic field propagated parallel to a transmission axis of the optical transport. The optical transport is constructed to enable the polarization to be controlled quickly using low magnetic field strength over very short optical paths. In some particular implementations, the optical transport includes optical fibers exhibiting high Verdet constants for the wavelengths of the transmitted radiation while concurrently preserving the waveguiding attributes of the fiber and otherwise providing for efficient construction of, and cooperative affectation of the radiation property(ies), by the property influencer.

The property influencer is a structure for implementing the property control of the radiation transmitted by the optical transport. In the preferred embodiment, the property influencer is operatively coupled to the optical transport, which in one implementation for an optical transport formed by an optical fiber having a core and one or more cladding layers, preferably the influencer is integrated into or on one or more of the cladding layers without significantly adversely altering the waveguiding attributes of the optical transport. In the preferred embodiment using the polarization property of transmitted radiation, the preferred implementation of the property influencer is a polarization influencing structure, such as a coil, coilform, or other structure capable of integration that supports/produces a Faraday Effect manifesting field in the optical transport (and thus affects the transmitted radiation) using one or more magnetic fields (one or more of which are controllable).

The structured waveguide of the present invention may serve in some embodiments as a transport in a modulator that controls an amplitude of propagated radiation. The radiation emitted by the modulator will have a maximum radiation amplitude and a minimum radiation amplitude, controlled by the interaction of the property influencer on the optical transport. Extinguishing simply refers to the minimum radiation amplitude being at a sufficiently low level (as appropriate for the particular embodiment) to be characterized as “off” or “dark” or other classification indicating an absence of radiation. In other words, in some applications a sufficiently low but detectable/discernable radiation amplitude may properly be identified as “extinguished” when that level meets the parameters for the implementation or embodiment. The present invention improves the response of the waveguide to the influencer by use of optically active constituents disposed in the guiding region during waveguide manufacture.

FIG. 1 is a general schematic plan view of a preferred embodiment of the present invention for a Faraday structured waveguide modulator 100. Modulator 100 includes an optical transport 105, a property influencer 110 operatively coupled to transport 105, a first property element 120, and a second property element 125.

Transport 105 may be implemented based upon many well-known optical waveguide structures of the art. For example, transport 105 may be a specially adapted optical fiber (conventional or PCF) having a guiding channel including a guiding region and one or more bounding regions (e.g., a core and one or more cladding layers for the core), or transport 105 may be a waveguide channel of a bulk device or substrate having one or more such guiding channels. A conventional waveguide structure is modified based upon the type of radiation property to be influenced and the nature of influencer 110.

Influencer 110 is a structure for manifesting property influence (directly or indirectly such as through the disclosed effects) on the radiation transmitted through transport 105 and/or on transport 105. Many different types of radiation properties may be influenced, and in many cases a particular structure used for influencing any given property may vary from implementation to implementation. In the preferred embodiment, properties that may be used in turn to control an output amplitude of the radiation are desirable properties for influence. For example, radiation polarization angle is one property that may be influenced and is a property that may be used to control a transmitted amplitude of the radiation. Use of another element, such as a fixed polarizer will control radiation amplitude based upon the polarization angle of the radiation compared to the transmission axis of the polarizer. Controlling the polarization angle varies the transmitted radiation in this example.

However, it is understood that other types of properties may be influenced as well and may be used to control output amplitude, such as for example, radiation phase or radiation frequency. Typically, other elements are used with modulator 100 to control output amplitude based upon the nature of the property and the type and degree of the influence on the property. In some embodiments another characteristic of the radiation may be desirably controlled rather than output amplitude, which may require that a radiation property other than those identified be controlled, or that the property may need to be controlled differently to achieve the desired control over the desired attribute.

A Faraday Effect is but one example of one way of achieving polarization control within transport 105. A preferred embodiment of influencer 110 for Faraday polarization rotation influence uses a combination of variable and fixed magnetic fields proximate to or integrated within/on transport 105. These magnetic fields are desirably generated so that a controlling magnetic field is oriented parallel to a propagation direction of radiation transmitted through transport 105. Properly controlling the direction and magnitude of the magnetic field relative to the transport achieves a desired degree of influence on the radiation polarization angle.

It is preferable in this particular example that transport 105 be constructed to improve/maximize the “influencibility” of the selected property by influencer 110. For the polarization rotation property using a Faraday Effect, transport 105 is doped, formed, processed, and/or treated to increase/maximize the Verdet constant. The greater the Verdet constant, the easier influencer 110 is able to influence the polarization rotation angle at a given field strength and transport length. In the preferred embodiment of this implementation, attention to the Verdet constant is the primary task with other features/attributes/characteristics of the waveguide aspect of transport 105 secondary. In the preferred embodiment, influencer 110 is integrated or otherwise “strongly associated” with transport 105 through the waveguide manufacturing process (e.g., the preform fabrication and/or drawing process), though some implementations may provide otherwise.

Element 120 and element 125 are property elements for selecting/filtering/operating on the desired radiation property to be influenced by influencer 110. Element 120 may be a filter to be used as a “gating” element to pass wave components of the input radiation having a desired state for the appropriate property, or it may be a “processing” element to conform one or more wave components of the input radiation to a desired state for the appropriate property. The gated/processed wave components from element 120 are provided to optical transport 105 and property influencer 110 controllably influences the transported wave components as described above.

Element 125 is a cooperative structure to element 120 and operates on the influenced wave components. Element 125 is a structure that passes WAVE_OUT and controls an amplitude of WAVE_OUT based upon a state of the property of the wave component. The nature and particulars of that control relate to the influenced property and the state of the property from element 120 and the specifics of how that initial state has been influenced by influencer 110.

For example, when the property to be influenced is a polarization property/polarization rotation angle of the wave components, element 120 and element 125 may be polarization filters. Element 120 selects one specific type of polarization for the wave component, for example right hand circular polarization. Influencer 110 controls a polarization rotation angle of radiation as it passes through transport 105. Element 125 filters the influenced wave component based upon the final polarization rotation angle as compared to a transmission angle of element 125. In other words, when the polarization rotation angle of the influenced wave component matches the transmission axis of element 125, WAVE_OUT has a high amplitude. When the polarization rotation angle of the influenced wave component is “crossed” with the transmission axis of element 125, WAVE_OUT has a low amplitude. A cross in this context refers to a rotation angle about ninety degrees misaligned with the transmission axis for conventional polarization filters.

Further, it is possible to establish the relative orientations of element 120 and element 125 so that a default condition results in a maximum amplitude of WAVE_OUT, a minimum amplitude of WAVE_OUT, or some value in between. A default condition refers to a magnitude of the output amplitude without influence from influencer 110. For example, by setting the transmission axis of element 125 at a ninety degree relationship to a transmission axis of element 120, the default condition would be a minimum amplitude for the preferred embodiment.

Element 120 and element 125 may be discrete components or one or both structures may be integrated onto or into transport 105. In some cases, the elements may be localized at an “input” and an “output” of transport 105 as in the preferred embodiment, while in other embodiments these elements may be distributed in particular regions of transport 105 or throughout transport 105.

In operation, radiation (shown as WAVE_IN) is incident to element 120 and an appropriate property (e.g., a right hand circular polarization (RCP) rotation component) is gated/processed to pass an RCP wave component to transport 105. Transport 105 transmits the RCP wave component until it is interacted with by element 125 and the wave component (shown as WAVE_OUT) is passed. Incident WAVE_IN typically has multiple orthogonal states to the polarization property (e.g., right hand circular polarization (RCP) and left hand circular polarization (LCP)). Element 120 produces a particular state for the polarization rotation property (e.g., passes one of the orthogonal states and blocks/shifts the other so only one state is passed). Influencer 110, in response to a control signal, influences that particular polarization rotation of the passed wave component and may change it as specified by the control signal. Influencer 110 of the preferred embodiment is able to influence the polarization rotation property over a range of about ninety degrees. Element 125 then interacts with the wave component as it has been influenced permitting the radiation amplitude of WAVE_IN to be modulated from a maximum value when the wave component polarization rotation matches the transmission axis of element 125 and a minimum value when the wave component polarization is “crossed” with the transmission axis. By use of element 120, the amplitude of WAVE_OUT of the preferred embodiment is variable from a maximum level to an extinguished level.

FIG. 2 is a detailed schematic plan view of a specific implementation of the preferred embodiment shown in FIG. 1. This implementation is described specifically to simplify the discussion, though the invention is not limited to this particular example. Faraday structured waveguide modulator 100 shown in FIG. 1 is a Faraday optical modulator 200 shown in FIG. 2.

Modulator 200 includes a core 205, a first cladding layer 210, a second cladding layer 215, a coil or coilform 220 (coil 220 having a first control node 225 and a second control node 230), an input element 235, and an output element 240. FIG. 3 is a sectional view of the preferred embodiment shown in FIG. 2 taken between element 235 and element 240 with like numerals showing the same or corresponding structures.

Core 205 may contain one or more of the following dopants added by standard fiber manufacturing techniques, e.g., variants on the vacuum deposition method: (a) color dye dopant (makes modulator 200 effectively a color filter alight from a source illumination system), and (b) an optically-active dopant, such as YIG/Bi—YIG or Tb or TGG or other dopant for increasing the Verdet constant of core 205 to achieve efficient Faraday rotation in the presence of an activating magnetic field. Heating or applying stress to the fiber during manufacturing adds holes or irregularities in core 205 to further increase the Verdet constant and/or implement non-linear effects. To simplify the discussion herein, the discussion focuses predominately on non-PCF waveguides. However, in the context of this discussion, PCF variants may be substituted for the non-PCF wavelength embodiments unless the context clearly is contrary to such substitution. For PCF waveguides, rather than use color dye dopants, color filtering is implemented using wavelength-selective bandgap coupling or longitudinal structures/voids may be filled and doped. Therefore, whenever color filtering/dye-doping is discussed in connection with non-PCF waveguides, the use of wavelength-selective bandgap coupling and/or filling and doping for PCF waveguides may also be substituted when appropriate.

Much silica optical fiber is manufactured with high levels of dopants relative to the silica percentage (this level may be as high as fifty percent dopants). Current dopant concentrations in silica structures of other kinds of fiber achieve about ninety-degree rotation in a distance of tens of microns. Conventional fiber manufacturers continue to achieve improvements in increasing dopant concentration (e.g., fibers commercially available from JDS Uniphase) and in controlling dopant profile (e.g., fibers commercially available from Corning Incorporated). Core 205 achieves sufficiently high and controlled concentrations of optically active dopants to provide requisite quick rotation with low power in micron-scale distances, with these power/distance values continuing to decrease as further improvements are made.

First cladding layer 210 (optional in the preferred embodiment) is doped with ferro-magnetic single-molecule magnets, which become permanently magnetized when exposed to a strong magnetic field. Magnetization of first cladding layer 210 may take place prior to the addition to core 205 or pre-form, or after modulator 200 (complete with core, cladding, coating(s) and/or elements) is drawn. During this process, either the preform or the drawn fiber passes through a strong permanent magnet field ninety degrees offset from a transmission axis of core 205. In the preferred embodiment, this magnetization is achieved by an electro-magnetic disposed as an element of a fiber pulling apparatus. First cladding layer 210 (with permanent magnetic properties) is provided to saturate the magnetic domains of the optically-active core 205, but does not change the angle of rotation of the radiation passing through fiber 200, since the direction of the magnetic field from layer 210 is at right-angles to the direction of propagation. The incorporated provisional application describes a method to optimize an orientation of a doped ferromagnetic cladding by pulverization of non-optimal nuclei in a crystalline structure.

As single-molecule magnets (SMMs) are discovered that may be magnetized at relative high temperatures, the use of these SMMs will be preferable as dopants. The use of these SMMs allow for production of superior doping concentrations and dopant profile control. Examples of commercially available single-molecule magnets and methods are available from ZettaCore, Inc. of Denver, Colo.

Second cladding layer 215 is doped with a ferrimagnetic or ferromagnetic material and is characterized by an appropriate hysteresis curve. The preferred embodiment uses a “short” curve that is also “wide” and “flat,” when generating the requisite field. When second cladding layer 215 is saturated by a magnetic field generated by an adjacent field-generating element (e.g., coil 220), itself driven by a signal (e.g., a control pulse) from a controller such as a switching matrix drive circuit (not shown), second cladding layer 215 quickly reaches a degree of magnetization appropriate to the degree of rotation desired for modulator 200. Further, second cladding layer 215 remains magnetized at or sufficiently near that level until a subsequent pulse either increases (current in the same direction), refreshes (no current or a +/−maintenance current), or reduces (current in the opposite direction) the magnetization level. This remanent flux of doped second cladding layer 215 maintains an appropriate degree of rotation over time without constant application of a field by influencer 110 (e.g., coil 220).

Appropriate modification/optimization of the doped ferri/ferromagnetic material may be further effected by ionic bombardment of the cladding at an appropriate process step. Reference is made to U.S. Pat. No. 6,103,010 entitled “METHOD OF DEPOSITING A FERROMAGNETIC FILM ON A WAVEGUIDE AND A MAGNETO-OPTIC COMPONENT COMPRISING A THIN FERROMAGNETIC FILM DEPOSITED BY THE METHOD” and assigned to Alcatel of Paris, France in which ferromagnetic thin-films deposited by vapor-phase methods on a waveguide are bombarded by ionic beams at an angle of incidence that pulverizes nuclei not ordered in a preferred crystalline structure. Alteration of crystalline structure is a method known to the art, and may be employed on a doped silica cladding, either in a fabricated fiber or on a doped preform material. The '010 patent is hereby expressly incorporated by reference for all purposes.

Similar to first cladding layer 210, suitable single-molecule magnets (SMMs) that are developed and which may be magnetized at relative high temperatures will be preferable as dopants in the preferred embodiment for second cladding layer 215 to allow for superior doping concentrations.

Coil 220 of the preferred embodiment is fabricated integrally on or in fiber 200 to generate an initial magnetic field. This magnetic field from coil 220 rotates the angle of polarization of radiation transmitted through core 205 and magnetizes the ferri/ferromagnetic dopant in second cladding layer 215. A combination of these magnetic fields maintains the desired angle of rotation for a desired period (such a time of a video frame when a matrix of fibers 200 collectively form a display as described in one of the related patent applications incorporated herein). For purposes of the present discussion, a “coilform” is defined as a structure similar to a coil in that a plurality of conductive segments are disposed parallel to each other and at right-angles to the axis of the fiber. As materials performance improves—that is, as the effective Verdet constant of a doped core increases by virtue of dopants of higher Verdet constant (or as augmented structural modifications, including those introducing non-linear effects)—the need for a coil or “coilform” surrounding the fiber element may be reduced or obviated, and simpler single bands or Gaussian cylinder structures will be practical. These structures (including the cylinder structures and coils and other similar structures), when serving the functions of the coilform described herein, are also included within the definition of coilform. The term coil and coilform may be used interchangeably when the context permits.

When considering the variables of the equation specifying the Faraday Effect: field strength, distance over which the field is applied, and the Verdet constant of the rotating medium, one consequence is that structures, components, and/or devices using modulator 200 are able to compensate for a coil or coilform formed of materials that produce less intense magnetic fields. Compensation may be achieved by making modulator 200 longer, or by further increasing/improving the effective Verdet constant. For example, in some implementations, coil 220 uses a conductive material that is a conductive polymer that is less efficient than a metal wire. In other implementations, coil 220 uses wider but fewer windings than otherwise would be used with a more efficient material. In still other instances, such as when coil 220 is fabricated by a convenient process but produces coil 220 having a less efficient operation, other parameters compensate as necessary to achieve suitable overall operation.

There are tradeoffs between design parameters—fiber length, Verdet constant of core, and peak field output and efficiency of the field-generating element. Taking these tradeoffs into consideration produces four preferred embodiments of an integrally-formed coilform, including: (1) twisted fiber to implement a coil/coilform, (2) fiber wrapped epitaxially with a thinfilm printed with conductive patterns to achieve multiple layers of windings, (3) printed by dip-pen nanolithography on fiber to fabricate a coil/coilform, and (4) coil/coilform wound with coated/doped glass fiber, or alternatively a conductive polymer that is metallically coated or uncoated, or a metallic wire. Further details of these embodiments are described in the related and incorporated provisional patent application referenced above.

Node 225 and node 230 receive a signal for inducing generation of the requisite magnetic fields in core 205, cladding layer 215, and coil 220. This signal in a simple embodiment is a DC (direct current) signal of the appropriate magnitude and duration to create the desired magnetic fields and rotate the polarization angle of the WAVE_IN radiation propagating through modulator 200. A controller (not shown) may provide this control signal when modulator 200 is used.

Input element 235 and output element 240 are polarization filters in the preferred embodiment, provided as discrete components or integrated into/onto core 205. Input element 235, as a polarizer, may be implemented in many different ways. Various polarization mechanisms may be employed that permit passage of light of a single polarization type (specific circular or linear) into core 205; the preferred embodiment uses a thin-film deposited epitaxially on an “input” end of core 205. An alternate preferred embodiment uses commercially available nano-scale microstructuring techniques on waveguide 200 to achieve polarization filtering (such as modification to silica in core 205 or a cladding layer as described in the incorporated Provisional Patent Application.) In some implementations for efficient input of light from one or more light source(s), a preferred illumination system may include a cavity to allow repeated reflection of light of the “wrong” initial polarization; thereby all light ultimately resolves into the admitted or “right” polarization. Optionally, especially depending on the distance from the illumination source to modulator 200, polarization-maintaining waveguides (fibers, semiconductor) may be employed.

Output element 240 of the preferred embodiment is a “polarization filter” element that is ninety degrees offset from the orientation of input element 235 for a default “off” modulator 200. (In some embodiments, the default may be made “on” by aligning the axes of the input and output elements. Similarly, other defaults such as fifty percent amplitude may be implemented by appropriate relationship of the input and output elements and suitable control from the influencer.) Element 240 is preferably a thin-film deposited epitaxially on an output end of core 205. Input element 235 and output element 240 may be configured differently from the configurations described here using other polarization filter/control systems. When the radiation property to be influenced includes a property other than a radiation polarization angle (e.g., phase or frequency), other input and output functions are used to properly gate/process/filter the desired property as described above to modulate the amplitude of WAVE_OUT responsive to the influencer.

FIG. 4 is a schematic block diagram of a preferred embodiment for a display assembly 400. Assembly 400 includes an aggregation of a plurality of picture elements (pixels) each generated by a waveguide modulator 200_{i,j} such as shown in FIG. 2. Control signals for control of each influencer of modulators 200_{i,j} are provided by a controller 405. A radiation source 410 provides source radiation for input/control by modulators 200i,j and a front panel may be used to arrange modulators 200_{i,j} into a desired pattern and or optionally provide post-output processing of one or more pixels.

Radiation source 410 may be unitary balanced-white or separate RGB/CMY tuned source or sources or other appropriate radiation frequency. Source(s) 410 may be remote from input ends of modulator 200_{i,j}, adjacent these input ends, or integrated onto/into modulator 200_{i,j}. In some implementations, a single source is used, while other implementations may use several or more (and in some cases, one source per modulator 200_{i,j}).

As discussed above, the preferred embodiment for the optical transport of modulator 200_{i,j} includes light channels in the form of special optical fibers. But semiconductor waveguide, waveguiding holes, or other optical waveguiding channels, including channels or regions formed through material “in depth,” are also encompassed within the scope of the present invention. These waveguiding elements are fundamental imaging structures of the display and incorporate, integrally, amplitude modulation mechanisms and color selection mechanisms. In the preferred embodiment for an FPD implementation, a length of each of the light channels is preferably on the order of about tens of microns (though the length may be different as described herein).

It is one feature of the preferred embodiment that a length of the optical transport is short (on the order of about 20 mm and shorter), and able to be continually shortened as the effective Verdet value increases and/or the magnetic field strength increases. The actual depth of a display will be a function of the channel length but because optical transport is a waveguide, the path need not be linear from the source to the output (the path length). In other words, the actual path may be bent to provide an even shallower effective depth in some implementations. The path length, as discussed above, is a function of the Verdet constant and the magnetic field strength and while the preferred embodiment provides for very short path lengths of a few millimeters and shorter, longer lengths may be used in some implementations as well. The necessary length is determined by the influencer to achieve the desired degree of influence/control over the input radiation. In the preferred embodiment for polarized radiation, this control is able to achieve about a ninety degree rotation. In some applications, when an extinguishing level is higher (e.g., brighter) then less rotation may be used which shortens the necessary path length. Thus, the path length is also influenced by the degree of desired influence on the wave component.

Controller 405 includes a number of alternatives for construction and assembly of a suitable switching system. The preferred implementation includes not only a point-to-point controller, it also encompasses a “matrix” that structurally combines and holds modulators 200_{i,j}, and electronically addresses each pixel. In the case of optical fibers, inherent in the nature of a fiber component is the potential for an all-fiber, textile construction and appropriate addressing of the fiber elements. Flexible meshes or solid matrixes are alternative structures, with attendant assembly methods.

It is one feature of the preferred embodiment that an output end of one or more modulators 200_{i,j} may be processed to improve its application. For example, the output ends of the waveguide structures, particularly when implemented as optical fibers, may be heat-treated and pulled to form tapered ends or otherwise abraded, twisted, or shaped for enhanced light scattering at the output ends, thereby improving viewing angle at the display surface. Some and/or all of the modulator output ends may be processed in similar or dissimilar ways to collectively produce a desired output structure achieving the desired result. For example, various focus, attenuation, color or other attribute(s) of the WAVE_OUT from one or more pixels may be controlled or affected by the processing of one or more output ends/corresponding panel location(s).

Front panel 415 may be simply a sheet of optical glass or other transparent optical material facing the polarization component or it may include additional functional and structural features. For example, panel 415 may include guides or other structures to arrange output ends of modulators 200_{i,j} into the desired relative orientation with neighboring modulators 200_{i,j}. FIG. 5 is a view of one arrangement for output ports 500_{x,y} of front panel 415 shown in FIG. 4. Other arrangements are possible are also possible depending upon the desired display (e.g., circular, elliptical or other regular/irregular geometric shape). When an application requires it, the active display area does not have to be contiguous pixels such that rings or “doughnut” displays are possible when appropriate. In other implementations, output ports may focus, disperse, filter, or perform other type of post-output processing on one or more pixels.

An optical geometry of a display or projector surface may itself vary in which waveguide ends terminate to a desired three-dimensional surface (e.g., a curved surface) which allows additional focusing capacity in sequence with additional optical elements and lenses (some of which may be included as part of panel 415). Some applications may require multiple areas of concave, flat, and/or convex surface regions, each with different curvatures and orientations with the present invention providing the appropriate output shape. In some applications, the specific geometry need not be fixed but may be dynamically alterable to change shapes/orientations/dimensions as desired. Implementations of the present invention may produce various types of haptic display systems as well.

In projection system implementations, radiation source 410, a “switching assembly” with controller 405 coupled to modulators 200_{i,j}, and front panel 415 may benefit from being housed in distinct modules or units, at some distance from each other. Regarding radiation source 410, in some embodiments it is advantageous to separate the illumination source(s) from the switching assembly due to heat produced by the types of high-amplitude light that is typically required to illuminate a large theatrical screen. Even when multiple illumination sources are used, distributing the heat output otherwise concentrated in, for instance, a single Xenon lamp, the heat output may still be large enough that the separation from the switching and display elements may be desirable. The illumination source(s) thus would be housed in an insulated case with heat sink and cooling elements. Fibers would then convey the light from the separate or unitary source to the switching assembly, and then projected onto the screen. The screen may include some features of front panel 415 or panel 415 may be used prior to illuminating an appropriate surface.

The separation of the switching assembly from the projection/display surface may have its own advantages. Placing the illumination and switching assembly in a projection system base (the same would hold true for an FPD) is able to reduce the depth of a projection TV cabinet. Or, the projection surface may be contained in a compact ball at the top of a thin lamp-like pole or hanging from the ceiling from a cable, in front projection systems employing a reflective fabric screen.

For theatrical projection, the potential to convey the image formed by the switching assembly, by means of waveguide structures from a unit on the floor, up to a compact final-optics unit at the projection window area, suggests a space-utilization strategy to accommodate both a traditional film projector and a new projector of the preferred embodiment in the same projection room, among other potential advantages and configurations.

A monolithic construction of waveguide strips, each with multiple thousands of waveguides on a strip, arranged or adhered side by side, may accomplish hi-definition imaging. However, “bulk” fiber optic component construction may also accomplish the requisite small projection surface area in the preferred embodiment. Single-mode fibers (especially without the durability performance requirements of external telecommunications cable) have a small enough diameter that the cross-sectional area of a fiber is quite small and suitable as a display pixel or sub-pixel.

In addition, integrated optics manufacturing techniques are expected to permit attenuator arrays of the present invention to be accomplished in the fabrication of a single semiconductor substrate or chip, massively monolithic or superficial.

In a fused-fiber projection surface, the fused-fiber surface may be then ground to achieve a curvature for the purpose of focusing an image into an optical array; alternatively, fiber-ends that are joined with adhesive or otherwise bound may have shaped tips and may be arranged at their terminus in a shaped matrix to achieve a curved surface, if necessary.

For projection televisions or other non-theatrical projection applications, the option of separating the illumination and switching modules from the projector surface enables novel ways of achieving less-bulky projection television cabinet construction.

FIG. 6 is a schematic representation of a preferred embodiment of the present invention for a portion 600 of the structured waveguide 205 shown in FIG. 2. Portion 600 is a radiation propagating channel of waveguide 205, typically a guiding channel (e.g., a core for a fiber waveguide) but may include one or more bounding regions (e.g., claddings for the fiber waveguide). Other waveguiding structures have different specific mechanisms for enhancing the waveguiding of radiation propagated along a transmission axis of a channel region of the waveguide. Waveguides include photonic crystal fibers, special thin-film stacks of structured materials and other materials. The specific mechanisms of waveguiding may vary from waveguide to waveguide, but the present invention may be adapted for use with the different structures.

For purposes of the present invention, the terms guiding region or guiding channel and bounding regions refer to cooperative structures for enhancing radiation propagation along the transmission axis of the channel. These structures are different from buffers or coatings or post-manufacture treatments of the waveguide. A principle difference is that the bounding regions are typically capable of propagating the wave component propagated through the guiding region while the other components of a waveguide do not. For example, in a multimode fiber optic waveguide, significant energy of higher-order modes is propagated through the bounding regions. One point of distinction is that the guiding region/bounding region(s) are substantially transparent to propagating radiation while the other supporting structures are generally substantially opaque.

As described above, influencer 110 works in cooperation with waveguide 205 to influence a property of a propagating wave component as it is transmitted along the transmission axis. Portion 600 is therefore said to have an influencer response attribute, and in the preferred embodiment this attribute is particularly structured to enhance the response of the property of the propagating wave to influencer 110. Portion 600 includes a plurality of constituents (e.g., rare-earth dopants 605, holes, 610, structural irregularities 615, microbubbles 620, and/or other elements 625) disposed in the guiding region and/or one or more bounding regions as desirable for any specific implementation. In the preferred embodiment, portion 600 has a very short length, in many cases less than about 25 millimeters, and as described above, sometimes significantly shorter than that. The influencer response attribute enhanced by these constituents is optimized for short length waveguides (for example as contrasted to telecommunications fibers optimized for very long lengths on the order of kilometers and greater, including attenuation and wavelength dispersion). The constituents of portion 600, being optimized for a different application, could seriously degrade telecommunications use of the waveguide. While the presence of the constituents is not intended to degrade telecommunications use, the focus of the preferred embodiment on enhancement of the influencer response attribute over telecommunications attribute(s) makes it possible for such degradation to occur and is not a drawback of the preferred embodiment.

The present invention contemplates that there are many different wave properties that may be influenced by different constructions of influencer 110; the preferred embodiment targets a Faraday-effect-related property of portion 600. As discussed above, the Faraday Effect induces a polarization rotation change responsive to a magnetic field parallel to a propagation direction. In the preferred embodiment, when influencer 110 generates a magnetic field parallel to the transmission axis, in portion 600 the amount of rotation is dependent upon the strength of the magnetic field, the length of portion 600, and the Verdet constant for portion 600. The constituents increase the responsiveness of portion 600 to this magnetic field, such as by increasing the effective Verdet constant of portion 600.

One significance of the paradigm shift in waveguide manufacture and characteristics by the present invention is that modification of manufacturing techniques used to make kilometer-lengths of optically-pure telecommunications grade waveguides enables manufacture of inexpensive kilometer-lengths of potentially optically-impure (but optically-active) influencer-responsive waveguides. As discussed above, some implementations of the preferred embodiment may use a myriad of very short lengths of waveguides modified as disclosed herein. Cost savings and other efficiencies/merits are realized by forming these collections from short length waveguides created from (e.g., cleaving) the longer manufactured waveguide as described herein. These cost savings and other efficiencies and merits include the advantages of using mature manufacturing techniques and equipment that have the potential to overcome many of the drawbacks of magneto-optic systems employing discrete conventionally produced magneto-optic crystals as system elements. For example, these drawbacks include a high cost of production, a lack of uniformity across a large number of magneto-optic crystals and a relatively large size of the individual components that limits the size of collections of individual components.

The preferred embodiment includes modifications to fiber waveguides and fiber waveguide manufacturing methodologies. At its most general, an optical fiber is a filament of transparent (at the wavelength of interest) dielectric material (typically glass or plastic) and usually circular in cross section that guides light. For early optical fibers, a cylindrical core was surrounded by, and in intimate contact with, a cladding of similar geometry. These optical fibers guided light by providing the core with slightly greater refractive index than that of the cladding layer. Other fiber types provide different guiding mechanisms—one of interest in the context of the present invention includes photonic crystal fibers (PCF) as described above.

Silica (silicon dioxide (SiO₂)) is the basic material of which the most common communication-grade optical fibers are made. Silica may occur in crystalline or amorphous form, and occurs naturally in impure forms such as quartz and sand. The Verdet constant is an optical constant that describes the strength of the Faraday Effect for a particular material. The Verdet constant for most materials, including silica is extremely small and is wavelength dependent. It is very strong in substances containing paramagnetic ions such as terbium (Tb). High Verdet constants are found in terbium doped dense flint glasses or in crystals of terbium gallium garnet (TGG). This material generally has excellent transparency properties and is very resistant to laser damage. Although the Faraday Effect is not chromatic (i.e. it doesn't depend on wavelength), the Verdet constant is quite strongly a function of wavelength. At 632.8 nm, the Verdet constant for TGG is reported to be −134 radT−1 whereas at 1064 nm, it has fallen to −40radT−1. This behavior means that the devices manufactured with a certain degree of rotation at one wavelength, will produce much less rotation at longer wavelengths.

The constituents may, in some implements, include an optically-active dopant, such as YIG/Bi—YIG or Tb or TGG or other best-performing dopant, which increases the Verdet constant of the waveguide to achieve efficient Faraday rotation in the presence of an activating magnetic field. Heating or stressing during the fiber manufacturing process as described below may further increase the Verdet constant by adding additional constituents (e.g., holes or irregularities) in portion 600. Rare-earths as used in conventional waveguides are employed as passive enhancements of transmission attributes elements, and are not used in optically-active applications.

Since silica optical fiber is manufactured with high levels of dopants relative to the silica percentage itself, as high as at least 50% dopants, and since requisite dopant concentrations have been demonstrated in silica structures of other kinds to achieve 90° rotation in tens of microns or less; and given improvements in increasing dopant concentrations (e.g., fibers commercially available from JDS Uniphase) and improvements in controlling dopant profiles (e.g., fibers, commercially available from Corning Incorporated), it is possible to achieve sufficiently high and controlled concentrations of optically-active dopant to induce rotation with low power in micron-scale distances.

FIG. 7 is a schematic block diagram of a representative waveguide manufacturing system 700 for making a preferred embodiment of a waveguide preform of the present invention. System 700 represents a modified chemical vapor deposition (MCVD) process to produce a glass rod referred to as the preform. The preform from a conventional process is a solid rod of ultra-pure glass, duplicating the optical properties of a desired fiber exactly, but with linear dimensions scaled-up two orders of magnitude or more. However, system 700 produces a preform that does not emphasize optical purity but optimizes for short-length optimization of influencer response. Preforms are typically made using one of the following chemical vapor deposition (CVD) methods: 1. Modified Chemical Vapor Deposition (MCVD), 2. Plasma Modified Chemical Vapor Deposition (PMCVD), 3. Plasma Chemical Vapor Deposition (PCVD), 4. Outside Vapor Deposition (OVD), 5. Vapor-phase Axial Deposition (AVD). All these methods are based on thermal chemical vapor reaction that forms oxides, which are deposited as layers of glass particles called soot, on the outside of a rotating rod or inside a glass tube. The same chemical reactions occur in these methods.

Various liquids (e.g., starting materials are solutions of SiCl₄, GeCl₄, POCl₃, and gaseous BCl₃) that provide the source for Si and dopants are heated in the presence in oxygen gas, each liquid in a heated bubbler 705 and gas from a source 710. These liquids are evaporated within an oxygen stream controlled by a mass-flow meter 715 and, with the gasses, form silica and other oxides from combustion of the glass-producing halides in a silica-lathe 720. Chemical reactions called oxidizing reactions occur in the vapor phase, as listed below:
GeCl₄+O₂=>GeO₂+2Cl₂
SiCl₄+O₂=>SiO₂+2Cl₂
4POCl₃+3O₂=>2P2O₅+6Cl₂
4BCl₃+3O₂=>2B₂O₃+6Cl₂

Germanium dioxide and phosphorus pentoxide increase the refractive index of glass, a boron oxide—decreases it. These oxides are known as dopants. Other bubblers 705 including suitable constituents for enhancing the influencer response attribute of the preform may be used in addition to those shown.

Changing composition of the mixture during the process influences a refractive index profile and constituent profile of the preform. The flow of oxygen is controlled by mixing valves 715, and reactant vapors 725 are blown into silica pipe 730 that includes a heated tube 735 where oxidizing takes places. Chlorine gas 740 is blown out of tube 735, but the oxide compounds are deposited in the tube in the form of soot 745. Concentrations of iron and copper impurity is reduced from about 10 ppb in the raw liquids to less than 1 ppb in soot 745.

Tube 735 is heated using a traversing H₂O₂ burner 750 and is continually rotated to vitrify soot 745 into a glass 755. By adjusting the relative flow of the various vapors 725, several layers with different indices of refraction are obtained, for example core versus cladding or variable core index profile for GI fibers. After the layering is completed, tube 735 is heated and collapsed into a rod with a round, solid cross-section, called the preform rod. In this step it is essential that center of the rod be completely filled with material and not hollow. The preform rod is then put into a furnace for drawing, as will be described in cooperation with FIG. 8.

The main advantage of MCVD is that the reactions and deposition occur in a closed space, so it is harder for undesired impurities to enter. The index profile of the fiber is easy to control, and the precision necessary for SM fibers can be achieved relatively easily. The equipment is simple to construct and control. A potentially significant limitation of the method is that the dimensions of the tube essentially limit the rod size. Thus, this technique forms fibers typically of 35 km in length, or 20-40 km at most. In addition, impurities in the silica tube, primarily H₂ and OH—, tend to diffuse into the fiber. Also, the process of melting the deposit to eliminate the hollow center of the preform rod sometimes causes a depression of the index of refraction in the core, which typically renders the fiber unsuitable for telecommunications use but is not generally of concern in the context of the present invention. In terms of cost and expense, the main disadvantage of the method is that the deposition rate is relatively slow because it employs indirect heating, that is tube 735 is heated, not the vapors directly, to initiate the oxidizing reactions and to vitrify the soot. The deposition rate is typically 0.5 to 2 g/min.

A variation of the above-described process makes rare-earth doped fibers. To make a rare-earth doped fiber, the process starts with a rare-earth doped preform—typically fabricated using a solution doping process. Initially, an optical cladding, consisting primarily of fused silica, is deposited on an inside of the substrate tube. Core material, which may also contain germanium, is then deposited at a reduced temperature to form a diffuse and permeable layer known as a ‘frit’. After deposition of the frit, this partially-completed preform is sealed at one end, removed from the lathe and a solution of suitable salts of the desired rare-earth dopant (e.g., neodymium, erbium, ytterbium etc.) is introduced. Over a fixed period of time, this solution is left to permeate the frit. After discarding any excess solution, the preform is returned to the lathe to be dried and consolidated. During consolidation, the interstices within the frit collapse and encapsulate the rare-earth. Finally, the preform is subjected to a controlled collapse, at high temperature to form a solid rod of glass—with a rare-earth incorporated into the core. Generally inclusion of rare-earths in fiber cables are not optically-active, that is, respond to electric or magnetic or other perturbation or field to affect a characteristic of light propagating through the doped medium. Conventional systems are the results of ongoing quests to increase the percentage of rare-earth dopants driven by a goal to improve “passive” transmission characteristics of waveguides (including telecommunications attributes). But the increased percentages of dopants in waveguide core/boundaries is advantageous for affecting optical-activity of the compound medium/structure for the preferred embodiment. As discussed above, in the preferred embodiment the percentage of dopants vs. silica is at least fifty percent.

FIG. 8 is a schematic diagram of a representative fiber drawing system 800 for making a preferred embodiment of the present invention from a preform 805, such as one produced from system 700 shown in FIG. 7. System 800 converts preform 805 into a hair-thin filament, typically performed by drawing. Preform 805 is mounted into a feed mechanism 810 attached near a top of a tower 815. Mechanism 810 lowers preform 805 until a tip enters into a high-purity graphite furnace 820. Pure gasses are injected into the furnace to provide a clean and conductive atmosphere. In furnace 820, tightly controlled temperatures approaching 1900° C. soften the tip of preform 805. Once the softening point of the preform tip is reached, gravity takes over and allows a molten gob to “free fall” until it has been stretched into a thin strand.

An operator threads this strand of fiber through a laser micrometer 825 and a series of processing stations 830x(e.g., for coatings and buffers) for producing a transport 835 that is wound onto a spool by a tractor 840, and the drawing process begins. The fiber is pulled by tractor 840 situated at the bottom of draw tower 815 and then wound on winding drums. During the draw, preform 805 is heated at the optimum temperature to achieve an ideal drawing tension. Draw speeds of 10-20 meters per second are not uncommon in the industry.

During the draw process the diameter of the drawn fiber is controlled to 125 microns within a tolerance of only 1 micron. Laser-based diameter gauge 825 monitors the diameter of the fiber. Gauge 825 samples the diameter of the fiber at rates in excess of 750 times per second. The actual value of the diameter is compared to the 125 micron target. Slight deviations from the target are converted to changes in draw speeds and fed to tractor 840 for correction.

Processing stations 830x typically include dies for applying a two layer protective coating to the fiber—a soft inner coating and a hard outer coating. This two-part protective jacket provides mechanical protection for handling while also protecting a pristine surface of the fiber from harsh environments. These coatings are cured by ultraviolet lamps, as part of the same or other processing stations 830x. Other stations 830x may provide apparatus/systems for increasing the influencer response attribute of transport 835 as it passes through the station(s). For example, various mechanical stressors, ion bombardment or other mechanism for introducing the influencer response attribute enhancing constituents at the drawing stage.

After spooled, the drawn fiber is tested for suitable optical and geometrical parameters. For transmission fibers, a tensile strength is usually tested first to ensure that a minimal tensile strength for the fiber has been achieved. After the first test, many different tests are performed, which for transmission fibers includes tests for transmission attributes, including: attenuation (decrease in signal strength over distance), bandwidth (information-carrying capacity; an important measurement for multimode fiber), numerical aperture (the measurement of the light acceptance angle of a fiber), cut-off wavelength (in single-mode fiber the wavelength above which only a single mode propagates), mode field diameter (in single-mode fiber the radial width of the light pulse in the fiber; important for interconnecting), and chromatic dispersion (the spreading of pulses of light due to rays of different wavelengths traveling at different speeds through the core; in single-mode fiber this is the limiting factor for information carrying capacity).

As has been described herein, the preferred embodiment of the present invention uses an optic fiber as a transport and primarily implements amplitude control by use of the “linear” Faraday Effect. While the Faraday Effect is a linear effect in which a polarization rotational angular change of propagating radiation is directly related to a magnitude of a magnetic field applied in the direction of propagation based upon the length over which the field is applied and the Verdet constant of the material through which the radiation is propagated. Materials used in a transport may not, however, have a linear response to an inducing magnetic field, e.g., such as from an influencer, in establishing a desired magnetic field strength. In this sense, an actual output amplitude of the propagated radiation may be non-linear in response to an applied signal from controller and/or influencer magnetic field and/or polarization and/or other attribute or characteristic of a modulator or of WAVE_IN. For purposes of the present discussion, characterization of the modulator (or element thereof) in terms of one or more system variables is referred to as an attenuation profile of the modulator (or element thereof).

Fiber fabrication processes continue to advance, in particular with reference to improving a doping concentration and as well as improving manipulation of dopant profiles, periodic doping of fiber during a production run, and related processing activities. U.S. Pat. No. 6,532,774, Method of Providing a High Level of Rare Earth Concentrations in Glass Fiber Preforms, demonstrates improved processes for co-doping of multiple dopants. Successes in increasing the concentration of dopants are anticipated to directly improves the linear Verdet constant of doped cores, as well as the performance of doped cores to facilitate non-linear effects as well.

Any given attenuation profile may be tailored to a particular embodiment, such as for example by controlling a composition, orientation, and/or ordering of a modulator or element thereof. For example, changing materials making up transport may change the “influencibility” of the transport or alter the degree to which the influencer “influences” any particular propagating wave_component. This is but one example of a composition attenuation profile. A modulator of the preferred embodiment enables attenuation smoothing in which different waveguiding channels have different attenuation profiles. For example in some implementations having attenuation profiles dependent on polarization handedness, a modulator may provide a transport for left handed polarized wave_components with a different attenuation profile than the attenuation profile used for the complementary waveguiding channel of a second transport for right handed polarized wave_components.

There are additional mechanisms for adjusting attenuation profiles in addition to the discussion above describing provision of differing material compositions for the transports. In some embodiments wave_component generation/modification may not be strictly “commutative” in response to an order of modulator elements that the propagating radiation traverses from WAVE_IN to WAVE_OUT. In these instances, it is possible to alter an attenuation profile by providing a different ordering of the non-commutative elements. This is but one example of a configuration attenuation profile. In other embodiments, establishing differing “rotational bias” for each waveguiding channel creates different attenuation profiles. As described above, some transports are configured with a predefined orientation between an input polarizer and an output polarizer/analyzer. For example, this angle may be zero degrees (typically defining a “normally ON” channel) or it may be ninety degrees (typically defining a “normally OFF” channel). Any given channel may have a different response in various angular displacement regions (that is, from zero to thirty degrees, from thirty to sixty degrees, and from sixty to ninety degrees). Different channels may be biased (for example with default “DC” influencer signals) into different displacement regions with the influencer influencing the propagating wave_component about this biased rotation. This is but one example of an operational attenuation profile. Several reasons are present that support having multiple waveguiding channels and to tailor/match/complement attenuation profiles for the channels. These reasons include power saving, efficiency, and uniformity in WAVE_OUT.

Bracketed by opposed polarization (selector) elements, a variable Faraday rotator or Faraday “attenuator” applies a variable field in the direction of the light path, allowing such a device to rotate the vector of polarization (e.g., from 0 through 90 degrees), permitting an increasing portion of the incident light that passed through the first polarizer to pass through the second polarizer. When no field is applied, then the light passing through the first polarizer is completely blocked by the second polarizer. When the proper “maximum” field is applied, then 100% of the light is rotated to the proper polarization angle, and 100% of the light passes through the second polarization element.

FIG. 9 is a general schematic diagram of a simplified unitary panel waveguide-based display 900 according to the preferred embodiment. Display 900 includes a casing 905 housing an illumination source 910, a switching matrix 915, and a display surface 920. Source 910 provides balanced white light or multiple channels of different colors/frequencies of a multicolor model (e.g., RGB sources). The preferred embodiment uses flexible waveguiding channels (e.g., optical fiber and the like) for source 910, matrix 915, and surface 920 integrated together as further explained below. Source 910 is either adjacent matrix 915 or faces matrix 915. When adjacent, fiber bundles convey radiation to an input side of matrix 915. Source 910 may include any of the radiation generation and characteristic/attribute control features set forth in the incorporated patent applications including polarization control.

Matrix 915 includes multiple waveguided channels for controlling an amplitude of radiation passing from its input proximate source 910 and an output proximate display surface 920. The options for the construction and function of matrix 915 are disclosed in detail in the incorporated patent applications. Matrix 915 may include optional tunable filters as well as influencer elements, some of which are integrated in-line or stacked. These waveguided channels may include fibers, waveguides, or other channelized materials made from conventional materials or photonic crystal. Any necessary channel isolation features are used, including lateral offset (staggering channels in three-dimensional space to sufficiently distance the individual channels or use of shielding structures for example). Matrix 915 may include any of the radiation generation and characteristic/attribute control features set forth in the incorporated patent applications including polarization analyzers on the output. In some implementations, an overlay sheet with periodic polarizer analyzer structures is used.

Display surface 920 may simply be a continuation of the waveguide channels of matrix 915 or a separate structure. Surface 920 has a range of implementations set forth in the incorporated patent applications including faceplate formation and use and channel-end modification for example. Structures at an input and/or output of surface 920 may include any of the radiation generation and characteristic/attribute control features set forth in the incorporated patent applications including thinfilms, optical glass or other optical material or structure.

FIG. 10 is a detailed schematic diagram of display 900 shown in FIG. 9. Illumination source 910 includes a light source 1005 and a polarization system 1010. Matrix 915 includes an attenuator/modulator structure 1015 having an integrated coilform with an input 1020 and an output 1025. Display surface 920 includes an analyzer 1030, an optional modified channel output 1035 and an optional display surface/protective coating.

FIG. 11 is a schematic diagram of an addressing grid 1100 according to a preferred embodiment of the present invention. As discussed herein as well as in the incorporated patent application, an element of display 900 is an influencer system for use in a modulation model. The preferred embodiment provides for a Faraday Effect as at least a part of the influencing system and to this end, display 900 uses coilforms for generation of the appropriate magnetic fields. As there may be hundreds, thousands, or more elements having a coilform structure, an efficient addressing system improves manufacturing and operational requirements. Addressing grid 1100 is an implementation of the preferred embodiment for an efficient addressing system.

Addressing grid 1100, which may be constructed as a passive or active matrix, is illustrated in both forms in FIG. 11. Grid 1100 includes an input contact 1105 and an output contact 1110 to produce an in-waveguide circuit path 1115 through the coilform/influencer element. An optional transparent transistor 1120 element is included for the active configuration (and absent in the passive mode). A four-quadrant schematic is but one of the possible embodiments of this approach. A consideration is a relative scaling of chip circuitry dimensions versus a diameter of the input fibers. The size of the circuitry dimensions should be small enough to pack enough conductive lines to individually address each fiber input-end. Spacing fibers may be retained all the way down through the fiber bundle in order to increase the spacing between fibers when necessary, or fibers of larger diameter may also be employed. The preferred choice will also depend on the size of the display or projection face.

In a passive matrix scheme, an “x” addressing line contacts an inner conductive ring or point on the fiber input-end, while a “y” addressing line contacts an outer conductive ring or point on the same fiber input end. The structure of the coilform or coil should be of the general principle as illustrated in FIG. 11, such that contact made on the inner ring or point is made to the coilform. Current then circulates through the windings or helical pattern around the core; then an outer thinfilm tape fabricated of sufficient insulating material and thickness and wound around the coilform is coated with conductive material as a thin margin on the interior contacting portion at the top edge of the coilform, and such coating continues around the edge of the thinfilm tape to the exterior face, down the face as a strip and terminating at the input end of the fiber. The resulting outer-ring contact point is insulated and spatially distinct from the inner-ring contact point.

The thinfilm tape is wound on fibers in the mass manufacturing process disclosed in the incorporated patent applications. To provide selected conductive points from the outside of the thin film to the inside, the film is perforated selectively with micro-perforations, achieved by mask-etching, laser, air-pressure perforation, or other methods known to the art before the printing or deposit of the conductive patterns. Thus, when the conductive material is deposited, in those regions with appropriately-sized perforations, the conductive material may be selectively-accessed or contacted through the perforations. Perforations may be circular or possess other geometries, including lines, squares, and more complicated combinations of shapes and shape-sizes.

An alternative, to provide selected conductive points from the outside layers of the fiber structure to the inside, the cladding or coating should be perforated selectively with micro-perforations, achieved by etching or other methods involving heating and stretching of a thin cladding and collapse of cavities resulting in oval holes disclosed elsewhere herein, or other methods known to the art before the printing or deposit of the conductive patterns. Thus, when the conductive material is deposited, in those regions with appropriately-sized perforations, the conductive material may be selectively-accessed or contacted through the perforations by the application of a conductor in liquid or powder form, which is then cured or annealed.

Also alternatively to the employment of printed thinfilms, an insulating coating is applied to the fiber during its bulk manufacture, but such coating is masked or the fiber is dipped in liquid polymer-type material only so far “up” the input end of the fiber such that a thin terminating edge of the coilform is left uncoated. Then a second coating is applied that is conductive, extending in this instance all the way up to the exposed conductive terminus of the coilform.

Thus, logic external to the grid area joined to the fiber bundle switches current at a particular “x” line and a particular “y” line addressing a particular subpixel. Current switched at an “x” coordinate, sends a pulse of appropriate current strength to the fiber subpixel element; that pulse passes “up” the coilform or coil, and back “down” the exterior conductive strip, continuing through the circuit down the “y” conductive line and completing the circuit.

In the unitary preferred embodiment shown in FIG. 9 and FIG. 10, it is a preferred embodiment to provide matrix 915 as a unitary sub-element. The incorporated patent applications employ weaving techniques of flexible optical waveguides to produce one or more of these integrated components. In a preferred embodiment, woven “X” addressing ribbons and woven “Y” addressing ribbons are used.

FIG. 12 is a schematic diagram of an “X” ribbon structural fiber system 1200 according to a preferred embodiment of the present invention. Fiber system 1200 includes a plurality of modulator segments 1205, each having an integrated influencer element 1210, for controlling an amplitude of individual channels as described herein and in the incorporated patent applications. In addition, system 1200 includes a plurality of structural elements 1215 and/or spacer elements 1220 as further described below. System 1200 further includes a conductive “X” addressing filament 1225 and a conductive “Y” addressing filament 1230 for an X/Y matrix addressing system. The conductive elements may be metal or conductive polymer or the like.

With fibers and filaments prepared in a precision, three-dimensional Jacquard loom apparatus, a ribbon is woven as illustrated in FIG. 12. The “vertical” optical fibers, in color batches and fabricated in bulk production runs according to the methods disclosed in the incorporated patent applications, (along with optional “spacing” filaments, also vertical), are set to be interwoven with structural fibers, depending on structural strength requirements, a minimum of about four microfibers, two each at the top and bottom—one of the lower of which will be a conductive polymer microfiber that accomplishes the “x” addressing of each optical fiber. Other conductive filaments or wires are possible; in particular filaments of Nanosonic, Inc.'s ‘rubber metal’ material, or other materials coated or wound with same; and materials or compound materials providing an optimal combination of tensile strength, elasticity, conductivity, and other properties desirable in a textile-fabrication paradigm may be expected to be commercially introduced, which will be superior to conventional metal wire for these purposes. Optionally, the conductive filament or fiber may be provided in addition to two purely structural fibers.

The need for the optional “spacing” filaments is determined by the relative diameter of the optical fiber segments as compared to the diameter of a subpixel, which is in turn determined by the size of the display and its resolution. A fiber diameter significantly smaller than the subpixel diameter will require at least one or more spacing filaments, unless, as is detailed below, multiple fibers are employed per subpixel, or other methods are employed, also detailed below. It is a virtue of the textile fabrication paradigm that adjacent Faraday attenuator/subpixel/pixel elements may be “vertically” offset from each other, as well as separated by spacing elements, as an additional means to isolate elements electrically and magnetically from each other, should such isolation be desirable.

In the case of both “x” and “y” addressing fibers, good contact is made at the relative “top” and “bottom” (near the output and input ends) of the fibers, as illustrated. The coilform or coil or other field generating element having provided superficial contacts on the fiber. As each fiber may function as a subpixel, and each ribbon is woven with dye-doped fiber of one color only, the number of vertical optical fibers will determined by resolution demands of the display they are specified for, and could range from hundreds to multiple thousands.

After weaving of the structural fibers and the addressing fiber, leaving a space between the upper and lower fixing points in the ribbon, a fixing adhesive may be applied to the ribbon before cutting. The structural and addressing fibers are hooked in removable tabs in a frame to either side. The ribbon is then tightened appropriately. Leaving spacing between ribbon rows, the process may be repeated, resulting in a long woven fabric run that may be de-loomed at a length optimal, as determined by textile manufacturing standards. The resulting fabric is taken up on spindles in a standard textile manufacturing manner. Once rolled onto spindles or holding frames, the loomed fabric is then moved to another textile handling apparatus in which the ribbons are cut from the long-fabric bolt. The vertical optical fibers and spacing fibers are cleaved above and below. The cleaving apparatus may also first apply heat to what will be the output ends of the optical fiber elements, and combined with the exertion of tension on the fibers by the loom apparatus as heating and softening of the fiber is effected, will result in an efficient stretching and modulation of the shape of the fiber ends. Thus a taper or a compression if the cleaving apparatus has a first heating bar constructed with rollers as the contact points, rotating at right angles to the axis of the fibers, then the cleaving apparatus may move parallel to the axis of the fibers and thus accomplish twisting or abrasion of the fiber ends as well. Other similar mechanical pressure, heating, and forming methods may obviously be applied to alter the shape and structure of the fiber ends before cleaving, to achieve increased scattering and dispersion characteristics at. Once cleaved, the resulting ribbon may be taken up on spools.

FIG. 13 is a schematic diagram of a “Y” ribbon structural fiber system 1300 according to a preferred embodiment of the present invention. Fiber system 1300 includes a plurality of modulators 1305 with one or more interposed first structural filaments 1310 and one or more interposed structural filaments/spacers 1315. One or more “X” addressing ribbons 1320 as shown in FIG. 12 are woven among the modulators 1305 and filaments/spacers 1315 as shown to provide the “X” address input for modulators 1305. A conductive “Y” filament 1325 completes the X/Y matrix addressing. Combination of fiber system 1200 and fiber system 1300 produces a woven switching matrix.

The “x” ribbons, composed of “lengthwise” structural filaments and an “x” addressing filament, as well as hundreds or thousands of “vertical” single-color dye-doped and fabricated optical fiber Faraday attenuator elements, are next set in another precision Jacquard loom machine, with hundreds or thousands of ribbons ultimately loomed into what will be the finished textile-woven switching matrix. Interwoven now with the parallel ribbons are “Y” structural filaments and a “Y” addressing filament, as shown, which, as woven into the “x” ribbons, form an equivalent “y” ribbon. The optical fiber axis of the ribbon (their width) is set perpendicular to the plane of the “y” filaments. Precision Jacquard looming allows for penetration of the gap between the upper and lower reinforcing structural filaments of the “X” ribbon, such that the thin “x” ribbon forms the depth of a textile “matte”, the surface of which consists of the projecting “output” ends of the optical fiber Faraday attenuator elements. Parallel to this “surface” are both the structural and “bottom” addressing filaments of the “X” ribbons, and the structural and “top” addressing filaments of the “Y” grid.

A removable “display frame” from a jacquard-type loom adapted for the present invention becomes a structural frame of the display and fixes the addressing filaments to the drive circuit, and which holds overall woven structure of switching matrix. Self-fixing by weaving at sides also enables implementation of individual hooks or fastening apparatus at the ends of each “x” and “y” row of the textile matte.

Once woven and tightened, the removable frame for the textile matte is removed from the loom. This frame will be used to fix the textile switching matrix matte in the final display case. The frame may be rigid or flexible, solid or textile, but is either fabricated with addressing logic (e.g., transistors) or conductive elements that contact each “X” and “Y” row and column. In addition, looming on the edges of the matte self-fixes the matte, by standard means of textile manufacturing, such that the matte may optionally be removed from the loom intact, with hooks or fastening elements fixed at the sides for each “X” ribbon and “Y” ribbon. Then the matte may be hooked or fastened by mans of these hooks or fastening apparatus into a display case structure, where the hooking or contact points for the “x” and “y” addressing filaments may make contact with the driving circuit for the display device. Once removed, or as may be convenient according to the numerous options in textile manufacturing, while still in the loom, the resulting textile matte may be saturated with a sol, such sol being dyed black to accomplish a black matrix, and UV cured. The sol then seals the textile lattice. A sol may be chosen to result in a flexible but sealed textile matte, or a rigid or semi-rigid structure, and with appropriate insulation and/or shielding properties.

Once cured, additional sol or liquid polymer may be spread over the cured, sealed textile matte/switching matrix surfaces, top and bottom in turn, if necessary. As the optical fiber elements of the output and input ends will extend above the horizontal filaments fixing and addressing them, additional flexible or rigid or semi-rigid material may be desirable to fill the space between the projecting ends of the optical fibers. The formation of even, flush output and input surfaces will enable the deposit of the polarization thin-film or sheet before the input ends, and after the output ends, of the optical fiber Faraday attenuator elements, although such films or sheets may be adhered or fixed into place between the input ends and the illumination source, and on an outside display optical glass or between the output ends and any final optics, including optical glass, by other means.

An alternative method for implementing the switching grid is to fabricate the textile matte structure without the addressing filaments, saturating with a sol and curing, additional liquid polymer smoothing of a top layer, and depositing by epitaxy a thinfilm printed with a standard FPD addressing grid, or by other standard semiconductor lithographic methods.

The switching matrix as woven textile structure paradigm applies to any scale of textile fabrication machinery, from the exemplary commercially available equipment and processes of Albany International Techniweave, to micro- and nano-scale textile-type fabrication, utilizing micro-assembly process apparatus and methods commercially available from Zyvex, in particular for textile-type manipulation of micro and nano-fibers and filaments with nanomanipulator systems, and Arryx optical tweezer methods. Such methods translate the textile paradigm, separately or advantageously in combination, to the smallest possible scale of assembly and components, realizing various forms of “nano-looming” systems.

While the preferred “all-fiber” textile-woven fiber-optic embodiment represents a superlative leveraging of the structural and waveguiding advantages of a fiber-optic based magneto-optic display of the present invention, there are additional variations on the methods of assembling, fixing the position, and addressing the optical fiber Faraday attenuator elements that offer their own several advantages.

FIG. 14 is a schematic diagram of a preferred embodiment for a modular switching matrix 1400 used in the display shown in FIG. 9 and FIG. 10. Matrix 1400 includes one or more “gripper sheets” 1405 holding and arranging a plurality of modulators 1410, preferably two or more facing sheets bonded or locked together to form a gripper block 1415. A gripper block 1415 includes a gripper-type stud connector 1420 for mating to a complementary receptacle 1425 also located in gripper block 1415. By stacking sheets 1405 to form blocks 1415 and arranging/locking multiple blocks 1415 an entire matrix 915 is formed, as further explained below. Blocks 1415 include embedded X/Y addressing matrix for coupling to the plurality of modulators 1410. In addition to the stud/receptacle mounting system, other inter-sheet/inter-block connecting systems may be employed, such as for example groove-flange and the like.

In this embodiment, commercially available Corning Gripper technology is modified, including the changes set forth below. Corning introduced its Polymer Gripper technology at an Optical Fiber Conference in March 2002, Gripper technology is a solution for a holding device that allows fibers to be snapped into place with sub-micron precision. Corning has extended the device's capabilities to include the holding and positioning of larger components such as ferrules, GRIN lenses and other optical elements with various geometries. Optical fiber fabricated according to one of the novel methods previously disclosed is cleaved into convenient multi-element (e.g., multiple doped, coilformed, segments fabricated in batch processes) lengths.

Optionally, sheets of Corning Gripper are fabricated, but modified with the inclusion of a conductive filament (preferably wire, or stiff polymer) laid in the liquid polymer before curing, at right angles to the direction of the troughs and suspended so as to be exposed at the height of the bottom of each trough. Also, they are positioned so that when a fiber is laid in the trough, the filament contacts the coilform or coil at either the input end or output end of the Faraday attenuator element. Filaments are laid at distances in the corning gripper sheet corresponding precisely to the periodic formation of the integrated Faraday attenuator structures in the fibers. Holes are also left in the gripper by a wire that is later removed after curing; such holes are oriented at right angles at the opposite relative end of the Faraday attenuator optical fiber element. In addition, on a back of the gripper sheets, on the side opposite the troughs, micro alignment tabs are formed in the Gripper material periodically, corresponding to the length of each Faraday attenuator fiber optic element. Also on the sides of each gripper sheet, in the same plane as the channels, are alternating micro-ridges/grooves or tabs/indentations, such that when such sheets are positioned side-by-side, they could be locked together.

Multiple optical fibers are loaded onto a Corning Gripper sheet and rolled by rubberized roller arrays into the Gripper channels until all channels are filled. A mirror Corning Gripper sheet is laid on top of the filled sheet and compressed to snap onto the fibers by a rubberized roller array. These gripper sheets have indentations formed in the backs periodically, to receive the tab structures fabricated on the backs of the bottom sheets.

Multiple such Corning Gripper Sheet sandwiches are fabricated. The tabs on the backs of the “bottom” sheets are inserted into the indentations in the backs of the “top sheets,” implementing the same locking process effected by the trough structures on the fibers themselves. These multiple Corning Gripper Sheets are further layered together and bonded with adhesive, supplementing the tab and indentation locking, forming blocks of two equal dimensions with hundreds or thousands of optical fiber elements per side, and a longer dimension corresponding to the axes of the fibers. Once an appropriately sized stack of such sheets are assembled into blocks, preferably in which the number of fibers laid in the sheet equals the number of sheets stacked and adhered, the stacks are cut periodically corresponding to the spaces between the periodic faraday attenuator structures in the batch-manufactured fibers. The sliced segments thus are in the form of “tiles,” which are mechanically collected as sliced and then conveyed and stored for use in combination to structurally form the display.

Optionally, prior to the slicing of each “tile,” in the case in which a conductive filament has been embedded in the gripper sheet, forming the “x” addressing, an extremely thin, hollow needle, coated with a thin film of lubricant if necessary, is punched at high velocity into and through the continuous hole originally formed by the wires left in each gripper sheet in their fabrication. A conductive filament has been inserted in the extremely thin needle and carried with it. The needle is removed from the hole, while the filament is held externally from the needle and remains with the needle retracted up its length and clear of the Gripper “block”. The filament is cut below the needle with slight pressure on the Gripper material, such that the resilient Gripper material rebounds making the cut exactly even with the surface of the Gripper at that point. The procedure is repeated alongside the next channel; in addition, multiple such needles may be employed in a single punch and fill mechanism, inserting filaments simultaneously in multiple channels. These conductive filaments form the “y” addressing in this optional implementation.

The final switching matrix structure is completed with the laying and alignment of a sufficient number of square tiles to form the required display size. A laser sensor array positioned beneath a transparent laying-up pan may be employed to ensure precision alignment of the tiles, but the alternating micro-ridges/grooves or tabs/indentations originally formed on the sides of each original, pre-stacked, pre-sliced sheets now form a plurality of ridges/grooves or tabs/indentations on two opposite sides of each tile, allowing for self-micro-alignment of tiles on one axis. Additionally, the other two sides of each tile are also fabricated with self-locking elements, tabs/indentations, enabling self-locking/snapping together of the tiles on that axis. The micro-alignment structures ensure continuous good contact between the embedded “x” and “y” addressing filaments, when optionally implemented.

When embedded “x” and “y” addressing filaments have not been implemented as part of the Gripper-based structure, then a mesh or thin-film layer imprinted or having been deposited with a switching matrix may be implemented on the bottom (for the “x” addressing”) and top (for the “y” addressing), or a combination of “x” and “y” addressing on one layer (as disclosed in the incorporated provisional patent application). When on one layer, precision alignment of the thin film to the appropriate contact points on an integrated Faraday attenuator optical fiber element must be performed, also as disclosed in the provisional patent application. Transistors may also be printed, as specified elsewhere herein, on a selected layer along with addressing lines in order to implement active matrix switching.

FIG. 15 is a schematic diagram of a first alternate preferred embodiment for a modular switching matrix 1500 used in the display shown in FIG. 9 and FIG. 10. Matrix 1500 includes a solid layer 1505 filled mechanically with a flexible waveguide channel 1510 having periodic sub-units each defining a modulator element 1515. One or more mechanical needles 1520 appropriately “sew” a desired pattern onto layer 1505 and a shearing system 1525 (e.g., a precision mechanical optical fiber cleaver) subdivides the waveguide channel into the modular elements. An X/Y addressing matrix may be disposed within or on layer 1505 to couple to and control the individual modulators.

Matrix 1500 is representative of a category of embodiments that includes a solid material, rigid or flexible, provided as a structural support for a specially-prepared flexible waveguide channel having a plurality of Faraday attenuator elements. Addressing may be made a part of the structure or a thinfilm or layer may be printed on the input and output faces, or both x and y addressing on one layer as specified in the previous embodiment. Transistors may also be printed a given layer to implement active-matrix switching.

In the case of a flexible solid sheet with holes, at least two alternatives of filling the holes with the Faraday attenuator optical fiber elements are practical. In one method, an array of hollow needles, filling multiple rows or squares of holes in batches but filling only alternating or every three holes each time, depending on the practical density tolerances of fitting a punch structure with multiple needles, is employed. That is, since the needle structure size is certainly larger than a hole, and since the needles must be filled with either fiber that is cut after punching or filled with pre-cut fiber segments, the space between needle structures and a superstructure filling the needles may necessitate filling alternate holes. A batch of every other or every third etc. holes are filled, by punching and pressure insertion of fiber from spools through the needle, or air-pressure insertion of a pre-cut fiber segment through the needle. After a batch of skipped holes is filled, a computer controlled apparatus moves to the next array of holes. Once the display has been covered in this way in one pass, filling every other, every third, or every fourth hole, etc. the filling apparatus resets and starts with the row immediately next to the first row filled. And the process of batch filling and resetting is repeated, for as many times as holes are skipped in a batch filling.

In a second method, a sewing apparatus is employed, in which a needle inserts a continuous thread of the batch-fabricated optical fiber. Here again, holes may be skipped and a display switching matrix sewn in multiple passes. But after each pass, a cutting mechanism is deployed as a bar and sharpened guillotine blade so that the continuously sewn fiber, passing under and over the solid sheet, is cut, leaving the optical fiber segments separated and vertically aligned with respect to the solid sheet. The flexible material of the solid sheet in this embodiment expands when the needle in either subtype is inserted, and rebounds to hold the fiber in place when the needle is removed.

FIG. 16 is a schematic diagram of a second alternate preferred embodiment for a modular switching matrix 1600 used in the display shown in FIG. 9 and FIG. 10. Matrix 1600 includes a layer 1605 having preformed apertures/holes 1610 for receiving modulator segments. One or more extended waveguide channel resources 1615 each including periodic modulator structures is processed (e.g., by a precision cleaving system) to produce a plurality of modulator segments 1620. These segments 1620 are deposited into an alignment/inserting system 1625 that guides appropriate segments 1620 into desired locations and inserts them into appropriate apertures 1610 as further described below. Layer 1605 may include the X/Y addressing matrix as described herein.

Matrix 1600 is an example of a case of a rigid solid sheet with holes in which a mechanical agitation process fills the holes with pre-cut Faraday attenuator optical fiber segments. In this method, color-subpixel rows are filled simultaneously, or if not by entire rows at the same time, in portions of a display row that are large batches processes optimally scaled. Multiple rows, alternating R, G, B, may be filled at the same time by the same process, outlined as set forth below.

Optical fiber fabricated according to the previously disclosed options or variants thereof is fed from multiple spools down into grooved trays set at an angle to thin feeder troughs, also grooved vertically. A cleaving device cuts the fiber in appropriate component segments, and the segments slide down the grooves and into the vertical grooves of the feeder trough. The spool array then shifts to the side to complete the filling of the adjacent set of grooves, until either the feeder trough is filled equal to the number of subpixels in a row, or until the optimal batch process-sized feeder trough is filled. At a base of the feeder trough is a removable slot that exposes holes in the bottom of the trough. Multiple troughs may be part of one feeder trough batch process computer-controlled manufacturing (CCM) device, and filled by the previous process.

The filled feeder trough or series of troughs, with multiple optical fiber component segments in vertical slots, is positioned above the rigid sheet. Beneath the solid sheet are two arrays of extremely thin, movable positioning guide-wires or filaments, two layers of two “x” and two “y” wires per subpixel hole. They are held apart by spring-tension. They are positioned in such a way as to bracket a segment that may fall into the hole above. The hole is fabricated to be of a larger diameter than the optical fiber component segments, and indeed of a large enough diameter to facilitate the easy passage of a optical fiber segment into the hole. The loom-type device holding the guide-wires is set at the same diameter as the hole in the rigid sheet, but the wires are movable. The wires or filaments are in tension and coated with a resin to provide a secure grip on a fiber segment that may be held by mechanical side tension of squeezing guide-wires. Beneath the guide-wires is another solid sheet, transparent with a movable laser sensor array deployed beneath.

After positioning just above but almost touching the row or rows or portions of row or rows to be filled, the slot or flap is moved and the holes exposed, while at the same time the trough begins to agitate slightly side-to-side or with a slight circular motion. The fiber component segments thus agitated drop from the slots in the feeder troughs and fill the holes beneath. Once the sensor array confirms the insertion of all fiber component segments into the holes to be filled by the batch process, the guide wires are released, and spring tension brings them into contact with the fiber, straightening the fibers and by virtue of being held just beneath the hole in the rigid material by an upper and lower guide wire, each coated in resin, positioning them at the center of the larger diameter holes in the rigid sheet. Next the entire apparatus, holding the rigid perforated sheet, guide-wire system, and bottom transparent sheet, is rotated 180 degrees.

Once the entire apparatus has been thus rotated, and the fiber components now suspended by the spring-tension guide-wires, a liquid polymer material is injected down onto the perforated solid sheet and flowed across the sheet to fill the gaps between optical fiber component segments and the sides of the perforations. This liquid polymer is then UV cured, fixing the position of the fibers at the center of the perforations. The guide-wires are then disengaged.

The rigid sheet may have been previously imprinted with an addressing grid, passive or active matrix (without or with transistors adjacent to each perforation, preferably on the side opposite that on which the liquid polymer had been injected and flowed). Or, addressing circuitry may be printed or deposited by methods referenced or disclosed elsewhere herein.

FIG. 17 is a schematic diagram of a third preferred embodiment for a modular switching matrix 1700 used in the display shown in FIG. 9 and FIG. 10. Matrix 1700 includes a mesh structure that is filled with individual waveguided modulator segments. Switching matrix 1700 includes a plurality of metalized bands 1705 forming the mesh structure. An “X” band or filament of mesh 1710 and a “Y” band or filament of mesh 1715 produce the X/Y addressing matrix. An input contact point 1720 provides input for the influencer mechanism (e.g., a coilform for example) of the transport component disposed within the spaces in the mesh structure.

In this embodiment, an assembly process is as disclosed for mechanically filling a flexible solid sheet as set forth above and in the incorporated provisional application. However, in the employment of a flexible mesh, the pre-woven mesh may also include addressing strips or filaments that may additionally “band” the optical fiber components and thereby form a multi-band field-generation structure or quasi-coilform. Interstices between mesh bands, strips or filaments, which may be formed in multiple woven layers, are filled in the same method as in the flexible solid sheet. Certain filaments or bands are formed of conductive polymer or are of a flexible synthetic material that has been metalized or coated with a conductive material. Bands of material are convenient in that once side may be coated distinctly from the other side.

These filaments or bands may only be paired as a one pair of “x” and “y” addressing wires only, and the coilform in this case is fabricated according to one of the methods disclosed in the incorporated patent applications, or variants thereof. But optionally, addressing transistors at the “x” and “y” axis may switch current to parallel filaments or bands in a multi-layer mesh, as illustrated. The interleaving multiple “x” and “y” bands or filaments contact the fibers in roughly horizontal bands, implementing a plurality of current segments at right angles to the axis of the fiber. When the modulating element is optionally fabricated with a square cladding, at least at this switching matrix stage (employing two dies or an adjustable die in the pulling process, as disclosed in the incorporated provisional application), then the bands or strips make virtually continuous contact with the doped cladding.

In addition to the specific embodiment shown in FIG. 17 in which a modulator element is positioned within the X and Y addressing bands so that an influencer control is coupled to control signals, an alternative to this ‘mesh’ implementation is possible. Specifically in this at least a portion of the influencer structure (e.g., the coilform) is implemented through textile banding, logic drives bands in parallel from display sides (X addressing combined with field generation) and made a part of the mesh structure. In this way, transport elements may be loaded in the mesh and not require precise alignment to make contact from the mesh to the influencer contacts. This is shown in FIG. 17 with a coilform structure 1725 integrated into the mesh for receiving a transport segment 1730. In the original embodiment of FIG. 17, coilform 1725 and transport segment 1730 are integrated as described above.

This embodiment employs a similar method of implementing the coilform through the switching matrix structural elements as that disclosed above. This case has the additional advantage, however, in that the weaving process effectively wraps the plurality of conductive elements snugly around the Faraday attenuator optical fiber components, ensuring close contact around a circular cladding fiber. This method of course may be combined with one or more of the methods disclosed elsewhere herein for fabricating a coilform or coil integrally around a suitably fabricated optical fiber.

This variant includes a mesh or textile structure that implements multi-layers, effectively, with respect to the length of the modulator fiber segments, to implement a winding. There are layers of mesh or woven textile between the input “x” grid and the output “y” grid, such that the optical filament is effectively “wrapped” with a quasi-winding. Instead of the coilform being fabricated in the fiber structure/during the fiber manufacturing process, it is implemented in the textile structure “in-depth.” A kind of “spiral box” is effected, using four conductive segments of four layers of textile to effect one “turn.” The layers between the “bottom” or “X” layer and the “top” or “y” layer are effectively passive (with respect to the addressing matrix) and would best be implemented by micro-striped filaments, whose conductive portions are only the length of the fiber diameter and extend, from the contact point with a (circular) fiber,” only the radius of the fiber plus the diameter of the previous conductive filament on the layer “below.”

In general, performance attributes of the transports, modulators, and systems embodying aspects of the present invention include the following. Sub-pixel diameter (including field generation elements adjacent to optically active material): preferably <100 microns more preferably <50 microns. (In an alternative embodiment discussed above multiple dye-doped light channels are implemented in one composite waveguide structure, effecting a net reduction in RGB pixel dimensions). Length of sub-pixel element: is preferably <100 microns and more preferably <50 microns. Drive current, to achieve effective 90° rotation, for a single sub-pixel: 0-50 m.Amps. Response time: Extremely high for Faraday rotators in general (i.e., 1 ns has been demonstrated).

As a base understanding of overall display power requirements, it is important to note that actual power requirements of the preferred embodiment are not necessarily calculated based on linear multiplication of the total number of sub-pixels times the maximum current required for 90° rotation. Actual average and peak power requirements must be calculated taking into account the following factors: Gamma and Average Color Sub-pixel Usage Both Significantly Below 100%: Thus Average Rotation Significantly Less than 90°: Gamma: Even a computer-monitor displaying a white background, using all sub-pixels, does not require maximum gamma for every sub-pixel, or for that matter, any sub-pixel. Space does not allow for a detailed review of the science of visual human perception. However, it is the relative intensity across the display, pixels and sub-pixels, (given a required base display luminance for viewing in varying ambient light levels), that is essential for proper image display. Maximum gamma (or close to it), and full rotation (across whatever operating range, 90° or some fraction thereof, would be required only in certain cases, including cases requiring the most extreme contrast, e.g., a direct shot into a bright light source, such as when shooting directly into the sun. Thus, an average gamma for a display will statistically be at some fraction of the maximum gamma possible. That is why, for comfortable viewing of a steady “white” background of a computer monitor, Faraday rotation will not be at a maximum, either. In sum, any given Faraday attenuator driving any given sub-pixel will rarely need to be at full rotation, thus rarely demanding full power. Color: Since only pure white requires an equally intense combination of RGB sub-pixels in a cluster, it should be noted that for either color or gray-scale images, it is a some fraction of the display's sub-pixels that will be addressed at any one time. Colors formed additively by RGB combination implies the following: some color pixels will require only one (either R, G, or B) sub-pixel (at varying intensity) to be “on”, some pixels will require two sub-pixels (at varying intensities) to be “on”, and some pixels will require three sub-pixels, (at varying intensities) to be “on”. Pure white pixels will require all three sub-pixels to be “on,” with their Faraday attenuators rotated to achieve equal intensity. (Color and white pixels can be juxtaposed to desaturate color; in one alternative embodiment of the present invention, an additional sub-pixel in a “cluster” may be balanced white-light, to achieve more efficient control over saturation).

In consideration of color and gray-scale imaging demands on sub-pixel clusters, it is apparent that, for the average frame, there will be some fraction of all display sub-pixels that actually need to be addressed, and for those that are “on” to some degree, the average intensity will be significantly less than maximum. This is simply due to the function of the sub-pixels in the RGB additive color scheme, and is a factor in addition to the consideration of absolute gamma.

Statistical analysis can determine the power demand profile of a FLAT active-matrix/continuously-addressed device due to these considerations. It is, in any event, significantly less than an imaginary maximum of each sub-pixel of the display simultaneously at full Faraday rotation. By no means are all sub-pixels “on” for any given frame, and intensities for those “on” are, for various reasons, typically at some relatively small fraction of maximum. Regarding current requirements, 0-50 m.amps for 0-90° Rotation is considered a Minimum Spec It is also important to note that an example current range for 0-90° rotation has been given (0-50 m.amps) from performance specs of existing Faraday attenuator devices, but this performance spec is provided as a minimum, already clearly being superseded and surpassed by the state-of-the-art of reference devices for optical communications. It most importantly does not reflect the novel embodiments specified in the present invention, including the benefits from improved methods and materials technology. Performance improvements have been ongoing since the achievement of the specs cited, and if anything have been and will continue to be accelerating, further reducing this range.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention, for example for the switching control, is as a routine in an operating system made up of programming steps or instructions resident in a memory of a computing system during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a preferred embodiment” or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Therefore the scope of the invention is to be determined solely by the appended claims.

1. A unitary display system, comprising:
an illumination system for generating a plurality of input wave_components in a first plurality of waveguide channels; and
a modulating system, integrated with said illumination system, for receiving said plurality of input wave_components in a second plurality of waveguide channels and producing a plurality of output wave_components collectively defining successive image sets.

2. The display system of claim 1 further comprising a display surface, integrated with said modulating system, for outputting said output wave_components.

3. The display system of claim 1 wherein said second plurality of waveguide channels include flexible optical channels.

4. The display system of claim 3 wherein a portion of said modulating system includes a plurality of woven channels of said second plurality of waveguide channels.

5. The display system of claim 1 wherein a portion of said modulating system includes a plurality of modulator elements periodically disposed in a planar substrate.

6. The display system of claim 5 wherein said substrate is a Gripper-type polymer sheet.

7. The display system of claim 1 wherein said modulating system includes an integrated X/Y addressing matrix coupled to said second plurality of waveguide channels.

8. The display system of claim 4 wherein said plurality of woven waveguide channels define a plurality of interstices each having a portion of an influencer element of said modulating system, wherein a transport segment is disposed within each said interstice.

9. A switching matrix, comprising:
a matrix of structural elements including an integrated addressing system defining a plurality of periodic interstices wherein said addressing system includes a contact system for said plurality of periodic interstices; and
a plurality of modulator elements, at least one disposed in each interstice of said plurality of periodic interstices wherein an influencer for each said modulator element is actuatable by said addressing system.

10. The switching matrix of claim 9 wherein said matrix is woven from flexible structural elements and flexible conductive elements.

11. The switching matrix of claim 9 wherein said influencers are integrated into said plurality of interstices.

12. A display manufacturing method, the method comprising:
a) forming an illumination system for generating a plurality of input wave_components in a first plurality of waveguide channels; and
b) forming a modulating system, integrated with said illumination system, for receiving said plurality of input wave_components in a second plurality of waveguide channels and producing a plurality of output wave_components collectively defining successive image sets.

13. The method of claim 12 wherein said forming step b) includes c) disposing modulator segments into interstices of a generally planar support, said support including an integrated addressing system coupled to each said interstice.

14. The method of claim 13 wherein said step c) includes forming each said interstice using a hollow needle, inserting a flexible transport resource into said formed interstice, and cleaving said inserted flexible transport resource to form a modulator segment for said interstice.

15. The method of claim 13 wherein said step c) includes forming each said interstice using a punch and inserting said modulator segment into said formed interstice.

16. A propagated signal on which is carried computer-executable instructions which when executed by a computing system performs a method, the method comprising:
a) forming an illumination system for generating a plurality of input wave_components in a first plurality of waveguide channels; and
b) forming a modulating system, integrated with said illumination system, for receiving said plurality of input wave_components in a second plurality of waveguide channels and producing a plurality of output wave_components collectively defining successive image sets.

17. The signal of claim 16 wherein said forming step b) includes c) disposing modulator segments into interstices of a generally planar support, said support including an integrated addressing system coupled to each said interstice.

18. The signal of claim 17 wherein said step c) includes forming each said interstice using a hollow needle, inserting a flexible transport resource into said formed interstice, and cleaving said inserted flexible transport resource to form a modulator segment for said interstice.

19. The signal of claim 17 wherein said step c) includes forming each said interstice using a punch and inserting said modulator segment into said formed interstice.
